(19) United States
(12) Patent Application Publication
(10) Pub. No.: US 2024/0172286 A1
(43) Pub. Date: May 23, 2024

(54) METHOD FOR UPLINK CHANNEL TRANSMISSION AND COMMUNICATION APPARATUS

(71) Applicant: BEIJING UNISOC COMMUNICATIONS TECHNOLOGY CO., LTD., Beijing (CN)

(72) Inventor: Huan ZHOU, Beijing (CN)

(21) Appl. No.: 18/552,963

(22) PCT Filed: Mar. 31, 2022
(86) PCT No.: PCT/CN2022/084678

§ 371 Date: Sep. 28, 2023

(30) Foreign Application Priority Data
Apr. 2, 2021 (CN) 202110363817.5

(51) Int. Cl. H04W 74/0816; H04W 72/1268; H04W 72/232; H04W 74/08

(52) U.S. Cl. CPC H04W 74/0816; H04W 72/1268; H04W 72/232; H04W 74/0866

(57) ABSTRACT

A method for uplink channel transmission and a communication apparatus are disclosed. The method includes the following. A terminal device determines a first time-domain resource unavailable for a physical uplink shared channel (PUSCH) repetition type B transmission, when a time-domain resource for the PUSCH repetition type B transmission overlaps an idle period in a fixed frame period for channel occupancy by a network device, and the terminal device is unable to transmit an uplink channel in the idle period. The terminal device segments the time-domain resource for the PUSCH repetition type B transmission into a second time-domain resource and a third time-domain resource based on the first time-domain resource, where the second time-domain resource is located before the first time-domain resource and the third time-domain resource is located after the first time-domain resource.

### CROSS-REFERENCE TO RELATED DISCLOSURE(S)

The application is a National Stage of International Application No. PCT/CN2022/084678, field Mar. 31, 2022, which claims priority to Chinese Patent Application No. 202110363817.5, field Apr. 2, 2021, the entire disclosure of which are incorporated herein by reference.

### TECHNICAL FIELD

This disclosure relates to the field of communication, and particularly to a method for uplink channel transmission and a communication apparatus.

### BACKGROUND

A 3^{rd} generation partnership project long term evaluation (3GPP LTE) system adopts a listen before talk (LBT) procedure to implement coexistence of licence assisted access (LAA) with different operators and other systems operating in unlicensed spectrum. The LBT procedure means that: in unlicensed spectrum, prior to data transmission, a base station (BS) firstly determines through a clear channel assessment (CCA) whether a current channel (in a unit of 20 megahertz (MHz)) is available. Data transmission supports two types of channel access. One type is frame based equipment (FBE), which is also referred to as semi-static channel occupancy; and the other type is load based equipment (LBE). In FBE, a period is configured, and the BS performs a channel detection at fixed time in each period. If a channel state of a channel is detected to be idle, the BS can occupy the channel for transmission. If the channel state of the channel is detected to be non-idle, the BS cannot occupy the channel in the period and has to wait until fixed time in the next period to perform another channel detection. As illustrated in FIG. 1, FIG. 1 is a schematic diagram of a fixed frame period for channel occupancy by a BS. The BS can perform channel access every fixed 20 milliseconds (ms) (two frames). Every 20 ms includes CCA detection time, channel occupancy time (COT), and an idle period in the fixed frame period.

In new radio (NR) standard release 16 (R16), in order to support an ultra reliability and low latency communication (URLLC) scenario, physical uplink shared channel (PUSCH) repetition type B is supported, which can satisfy a requirement for URLLC latency and can also enhance reliability of a URLLC service. PUSCH repetition type B transmission may occur in one slot or over slots.

Currently, a protocol merely supports initial channel-occupancy of the BS, but does not support initial channel-occupancy of a terminal device. Since the terminal device needs to perform data transmission in some cases, the initial channel-occupancy of the terminal device is studied. If higher-layer signaling of the BS indicates that the terminal device cannot transmit an uplink channel or a signal in an idle period in the fixed frame period for channel occupancy by the BS, and a duration for the PUSCH repetition type B transmission overlaps the idle period in the fixed frame period for channel occupancy by the BS, the terminal device cannot transmit the uplink channel despite successful channel access, thereby affecting the PUSCH repetition type B transmission of the terminal device.

### SUMMARY

In a first aspect, a method for uplink channel transmission is provided in the disclosure. The method includes the following. A terminal device determines a first time-domain resource unavailable for a PUSCH repetition type B transmission, when a time-domain resource for the PUSCH repetition type B transmission overlaps an idle period in a fixed frame period for channel occupancy by a network device, and the terminal device is unable to transmit an uplink channel in the idle period. The terminal device segments the time-domain resource for the PUSCH repetition type B transmission into a second time-domain resource and a third time-domain resource based on the first time-domain resource, where the second time-domain resource is located before the first time-domain resource and the third time-domain resource is located after the first time-domain resource.

In a second aspect, a communication apparatus is provided in the disclosure. The communication apparatus includes a processor and a memory. The memory is configured to store computer execution instructions. The processor is configured to invoke program codes stored in the memory, so as to perform the method in the first aspect or the second aspect and the method in any one of possible embodiments of the first aspect or the second aspect.

In a third aspect, a non-transitory computer-readable storage medium is provided in the disclosure. The non-transitory computer-readable storage medium is configured to store computer-readable instructions, which, when executed by a communication apparatus, are operable with the communication apparatus to perform the method in the first aspect or the second aspect and the method in any one of possible embodiments of the first aspect or the second aspect.

### BRIEF DESCRIPTION OF THE DRAWINGS

In order for clarity in elaboration of technical solutions of embodiments of the disclosure, the following will give a brief introduction to the accompanying drawings used for describing the embodiments. Apparently, the accompanying drawings described below are some embodiments of the disclosure. Based on these drawings, those of ordinary skill in the art can also obtain other drawings without creative effort.

FIG. 1 is a schematic diagram of a fixed frame period for channel occupancy by a base station (BS) provided in embodiments of the disclosure.

FIG. 2 is a schematic diagram of a network architecture provided in embodiments of the disclosure.

FIG. 3 is a schematic diagram illustrating a repetition transmission in the same slot provided in embodiments of the disclosure.

FIG. 4 is a schematic diagram illustrating a repetition transmission over slots provided in embodiments of the disclosure.

FIG. 5 is a flowchart of a method for uplink channel transmission provided in embodiments of the disclosure.

FIG. 6 is a schematic diagram illustrating channel occupancy, respectively, by a terminal device and a network device, provided in embodiments of the disclosure.

FIG. 7 is a flowchart of another method for uplink channel transmission provided in embodiments of the disclosure.

FIG. 8 is a schematic diagram illustrating segmentation of a time-domain resource for a physical uplink shared channel (PUSCH) repetition transmission provided in embodiments of the disclosure.

FIG. 9A is a schematic diagram of a target slot symbol provided in embodiments of the disclosure.

FIG. 9B is a schematic diagram of another target slot symbol provided in embodiments of the disclosure.

FIG. 9C is a schematic diagram of yet another target slot symbol provided in embodiments of the disclosure.

FIG. 9D is a schematic diagram of yet another target slot symbol provided in embodiments of the disclosure.

FIG. 10 is a schematic diagram of yet another target slot symbol provided in embodiments of the disclosure.

FIG. 11 is a schematic diagram illustrating target slot symbol padding provided in embodiments of the disclosure.

FIG. 12 is a schematic diagram illustrating another target slot symbol padding provided in embodiments of the disclosure.

FIG. 13 is a schematic diagram illustrating yet another target slot symbol padding provided in embodiments of the disclosure.

FIG. 14 is a schematic diagram illustrating yet another target slot symbol padding provided in embodiments of the disclosure.

FIG. 15 is a schematic diagram illustrating yet another target slot symbol padding provided in embodiments of the disclosure.

FIG. 16 is a flowchart of yet another method for uplink channel transmission provided in embodiments of the disclosure.

FIG. 17 is a flowchart of yet another method for uplink channel transmission provided in embodiments of the disclosure.

FIG. 18A is a schematic diagram of yet another target slot symbol provided in embodiments of the disclosure.

FIG. 18B is a schematic diagram of yet another target slot symbol provided in embodiments of the disclosure.

FIG. 18C is a schematic diagram of yet another target slot symbol provided in embodiments of the disclosure.

FIG. 19 is a schematic diagram illustrating yet another target slot symbol padding provided in embodiments of the disclosure.

FIG. 20 is a schematic diagram illustrating yet another target slot symbol padding provided in embodiments of the disclosure.

FIG. 21 is a schematic diagram illustrating yet another target slot symbol padding provided in embodiments of the disclosure.

FIG. 22 is a schematic diagram illustrating yet another target slot symbol padding provided in embodiments of the disclosure.

FIG. 23 is a schematic structural diagram of a communication apparatus provided in embodiments of the disclosure.

FIG. 24 is a schematic structural diagram of yet another communication apparatus provided in embodiments of the disclosure.

FIG. 25 is a schematic structural diagram of a module device provided in embodiments of the disclosure.

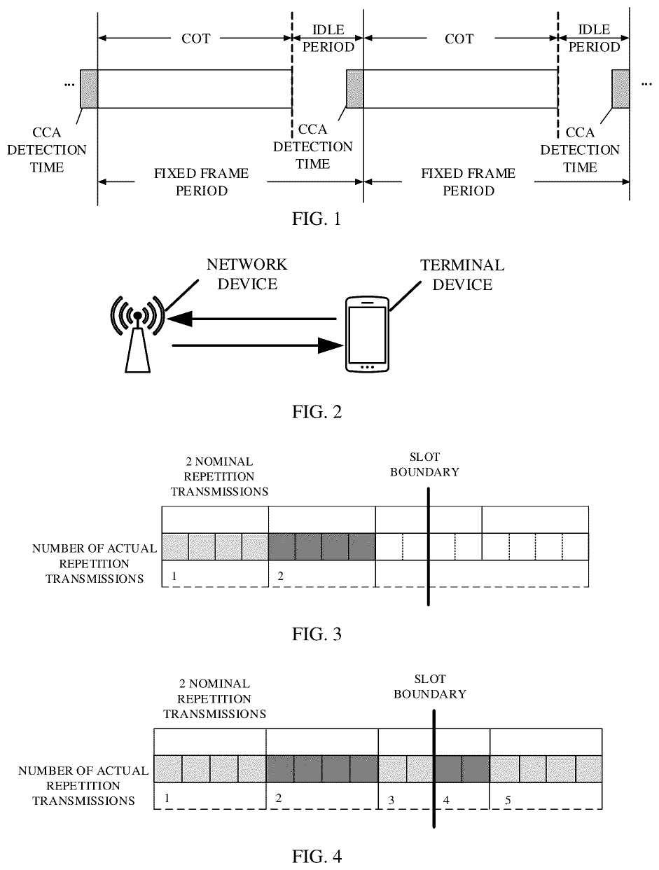

### DETAILED DESCRIPTION

The following will describe technical solutions of embodiments of the disclosure clearly and completely with reference to the accompanying drawings in embodiments of the disclosure. Apparently, embodiments described herein are merely some embodiments, rather than all embodiments, of the disclosure. Based on the embodiments of the disclosure, all other embodiments obtained by those of ordinary skill in the art without creative effort shall fall within the protection scope of the disclosure.

The terms used herein in embodiments of the disclosure are only for the purpose of describing a particular embodiment rather than limiting the disclosure. As used in the specification and the claims of the disclosure, singular forms “a”, “an”, and “the” are intended to include plural forms as well, unless otherwise indicated explicitly in the context. It may be understood that, the term “and/or” in this disclosure refers to any or all of possible combinations of one or more items that are listed.

It is to be noted that, the terms “first”, “second”, “third”, and the like used in the specification, the claims, and the accompanying drawings of the disclosure are used to distinguish similar objects rather than describing a particular order or a precedence order. It may be understood that, the data used that way may be interchangeable where appropriate, so that the embodiments of the disclosure described herein can be implemented in sequences other than those illustrated or described herein. In addition, the terms “include”, “comprise”, and “have” as well as variations thereof are intended to cover non-exclusive inclusion. For example, a procedure, a method, a system, a product, or a server that includes a series of steps or units is not necessarily limited to those steps or units that are listed explicitly, but may include other steps or units that are not listed explicitly or include other steps or units that are inherent to such a procedure, a method, a product, or a device.

A method for uplink channel transmission, a communication apparatus, a chip, and a module device are provided in the disclosure, which can avoid a physical uplink shared channel (PUSCH) repetition type B transmission failure when higher-layer signaling of a network device indicates that a terminal device cannot transmit an uplink channel or a signal in an idle period in a fixed frame period for channel occupancy by the network device, and a duration for PUSCH repetition type B transmission overlaps the idle period in the fixed frame period for channel occupancy by the network device.

In a first aspect, a method for uplink channel transmission is provided in the disclosure. The method includes the following. A terminal device determines a first time-domain resource unavailable for a PUSCH repetition type B transmission, when a time-domain resource for the PUSCH repetition type B transmission overlaps an idle period in a fixed frame period for channel occupancy by a network device, and the terminal device is unable to transmit an uplink channel in the idle period. The terminal device segments the time-domain resource for the PUSCH repetition type B transmission into a second time-domain resource and a third time-domain resource based on the first time-domain resource, where the second time-domain resource is located before the first time-domain resource and the third time-domain resource is located after the first time-domain resource.

Based on the method described in the first aspect, the terminal device determines a time-domain resource unavailable for the PUSCH repetition type B transmission, and segments the time-domain resource for the PUSCH repetition type B transmission into the second time-domain resource and the third time-domain resource based on the time-domain resource unavailable for the PUSCH repetition type B transmission, so that the terminal device can subsequently perform the PUSCH repetition type B transmission in the second time-domain resource and in the third time-domain resource. Therefore, based on the method described in the first aspect, it is conducive to avoiding a PUSCH repetition type B transmission failure.

In a possible embodiment, the method further includes the following. The terminal device performs the PUSCH repetition type B transmission in the second time-domain resource. The terminal device performs the PUSCH repetition type B transmission in the third time-domain resource when receiving a downlink channel transmission. Based on the method, the PUSCH repetition type B transmission failure can be avoided.

In a possible embodiment, the method further includes the following. The terminal device performs the PUSCH repetition type B transmission in the third time-domain resource and in a clear channel when the terminal device does not receive any downlink channel transmission and the clear channel is detected. Based on the method, the PUSCH repetition type B transmission failure can be avoided.

In a possible embodiment, the downlink channel transmission is first indication information, and the first indication information indicates the terminal device to perform the PUSCH repetition type B transmission in the third time-domain resource. Based on the method, it is conducive to enhancing flexibility of scheduling of the network device.

In a possible embodiment, the method further includes the following. The terminal device pads a target slot symbol when the target slot symbol exists, where the target slot symbol is a slot symbol between the first time-domain resource and the second time-domain resource, or the target slot symbol is a slot symbol between the first time-domain resource and the third time-domain resource, or the target slot symbol is a slot symbol before or after a slot boundary in the second time-domain resource, or the target slot symbol is a slot symbol before or after a slot boundary in the third time-domain resource. Based on the method, it is conducive to preventing the terminal device in unlicensed spectrum from re-accessing a channel due to an orphan slot symbol being empty for a long time.

In a possible embodiment, before the terminal device segments the time-domain resource for the PUSCH repetition type B transmission into the second time-domain resource and the third time-domain resource based on the first time-domain resource, the method includes the following. The terminal device pads a target slot symbol when the target slot symbol exists, where the target slot symbol is a slot symbol between two adjacent PUSCH transmissions in one or more PUSCH transmissions, or the target slot symbol is a slot symbol before a first PUSCH transmission in the one or more PUSCH transmissions, or the target slot symbol is a slot symbol after a last PUSCH transmission in the one or more PUSCH transmissions; where the multiple PUSCH transmissions are obtained by segmenting a PUSCH and the PUSCH repetition type B transmission. Based on the method, it is conducive to preventing the terminal device in unlicensed spectrum from re-accessing a channel due to an orphan slot symbol being empty for a long time.

In a possible embodiment, the target slot symbol is the slot symbol between the first time-domain resource and the second time-domain resource, or the target slot symbol is the slot symbol between the first time-domain resource and the third time-domain resource. The terminal device pads the target slot symbol as follows. The terminal device pads the target slot symbol by using an extended cyclic prefix (CP) of a first slot symbol in the third time-domain resource. Based on the method, the terminal device does not have to generate new data to pad an orphan slot symbol, which can make a method for orphan slot symbol padding simpler.

In a possible embodiment, the terminal device pads the target slot symbol as follows. The terminal device pads the target slot symbol by using an extended CP of a next slot symbol to the target slot symbol. Alternatively, the terminal device pads the target slot symbol by using an extended CP of a previous slot symbol to the target slot symbol. Based on the method, the terminal device does not have to generate new data to pad an orphan slot symbol, which can make a method for orphan slot symbol padding simpler.

In a possible embodiment, the terminal device pads the target slot symbol as follows. The terminal device pads the target slot symbol by using data in a first slot symbol for a next PUSCH repetition type B transmission. Alternatively, the terminal device pads the target slot symbol by using data in a last slot symbol for a previous PUSCH repetition type B transmission. Based on the method, the terminal device does not have to generate new data to pad an orphan slot symbol, which can make a method for orphan slot symbol padding simpler.

In a possible embodiment, the terminal device determines the first time-domain resource unavailable for the PUSCH repetition type B transmission as follows. The terminal device determines the idle period as the first time-domain resource unavailable for the PUSCH repetition type B transmission. Based on the method, the terminal device itself determines the time-domain resource unavailable for the PUSCH repetition type B transmission without a need for an indication from the network device, which is conducive to reducing signaling overhead.

In a possible embodiment, the terminal device determines the first time-domain resource unavailable for the PUSCH repetition type B transmission as follows. The terminal device receives second indication information from the network device, where the second indication information indicates the time-domain resource unavailable for the PUSCH repetition type B transmission. The terminal device determines the first time-domain resource unavailable for the PUSCH repetition type B transmission based on the second indication information. Based on the method, it is conducive to enhancing flexibility of configuration for the time-domain resource unavailable for the PUSCH repetition type B transmission.

In a possible embodiment, the PUSCH repetition type B transmission is a dynamically scheduled PUSCH repetition transmission or a scheduled and granted PUSCH repetition transmission activated by a physical downlink control channel (PDCCH). The terminal device segments the time-domain resource for the PUSCH repetition type B transmission into the second time-domain resource and the third time-domain resource based on the first time-domain resource as follows. The terminal device segments the time-domain resource for the PUSCH repetition type B transmission into the second time-domain resource and the third time-domain resource based on the first time-domain resource, when the terminal device receives third indication information and downlink control information (DCI) from the network device, and the third indication information indicates existence of fourth indication information in the DCI, and the fourth indication information indicates validity of the second indication information; where the third indication information indicates whether the fourth indication information exists in the DCI, and the fourth indication information indicates whether the second indication information is valid. Based on the method, it is conducive to enhancing flexibility of scheduling of the network device.

In a possible embodiment, the method further includes the following. The terminal device segments the time-domain resource for the PUSCH repetition type B transmission into the second time-domain resource and the third time-domain resource based on the first time-domain resource, when the terminal device receives the third indication information and the DCI from the network device, and the third indication information indicates absence of the fourth indication information in the DCI. Based on the method, it is conducive to enhancing flexibility of scheduling of the network device.

In a possible embodiment, the PUSCH repetition type B transmission is a scheduled and granted PUSCH repetition transmission activated by a non-PDCCH. The terminal device segments the time-domain resource for the PUSCH repetition type B transmission into the second time-domain resource and the third time-domain resource based on the first time-domain resource as follows. The terminal device segments the time-domain resource for the PUSCH repetition type B transmission into the second time-domain resource and the third time-domain resource based on the first time-domain resource, when not receiving third indication information from the network device; where the third indication information indicates whether fourth indication information exists in DCI, and the fourth indication information indicates whether the second indication information is valid. Based on the method, it is conducive to enhancing flexibility of scheduling of the network device.

In a second aspect, a method for slot symbol padding is provided in the disclosure. The method includes the following. The terminal device pads a target slot symbol, where the target slot symbol is a slot symbol between two adjacent PUSCH transmissions in one or more PUSCH transmissions, or the target slot symbol is a slot symbol before a first PUSCH transmission in the one or more PUSCH transmissions, or the target slot symbol is a slot symbol after a last PUSCH transmission in the one or more PUSCH transmissions; where the multiple PUSCH transmissions are obtained by segmenting a PUSCH and a PUSCH repetition transmission. Based on the method described in the first aspect, it is conducive to preventing the terminal device in unlicensed spectrum from re-accessing a channel due to an orphan slot symbol being empty for a long time.

In a possible embodiment, the terminal device pads the target slot symbol as follows. The terminal device pads the target slot symbol by using an extended CP of a next slot symbol to the target slot symbol. Based on the method, the terminal device does not have to generate new data to pad an orphan slot symbol, which can make a method for orphan slot symbol padding simpler.

In a possible embodiment, the terminal device pads the target slot symbol as follows. The terminal device pads the target slot symbol by using an extended CP of a previous slot symbol to the target slot symbol. Based on the method, the terminal device does not have to generate new data to pad an orphan slot symbol, which can make a method for orphan slot symbol padding simpler.

In a possible embodiment, the terminal device pads the target slot symbol as follows. The terminal device pads the target slot symbol by using data in a first slot symbol for a next PUSCH repetition transmission. Based on the method, the terminal device does not have to generate new data to pad an orphan slot symbol, which can make a method for orphan slot symbol padding simpler.

In a possible embodiment, the terminal device pads the target slot symbol as follows. The terminal device pads the target slot symbol by using data in a last slot symbol for a previous PUSCH repetition transmission. Based on the method, the terminal device does not have to generate new data to pad an orphan slot symbol, which can make a method for orphan slot symbol padding simpler.

In a third aspect, a communication apparatus is provided in the disclosure. The communication apparatus includes a unit configured to implement the method in the first aspect or the second aspect and the method in any one of possible embodiments of the first aspect or the second aspect.

In a fourth aspect, a communication apparatus is provided in the disclosure. The communication apparatus includes a processor. The processor is configured to perform the method in the first aspect or the second aspect and the method in any one of possible embodiments of the first aspect or the second aspect.

In a fifth aspect, a communication apparatus is provided in the disclosure. The communication apparatus includes a processor and a memory. The memory is configured to store computer execution instructions. The processor is configured to invoke program codes stored in the memory, so as to perform the method in the first aspect or the second aspect and the method in any one of possible embodiments of the first aspect or the second aspect.

In a sixth aspect, a communication apparatus is provided in the disclosure. The communication apparatus includes a processor and a transceiver. The transceiver is configured to receive a signal or transmit the signal. The processor is configured to perform the method in the first aspect or the second aspect and the method in any one of possible embodiments of the first aspect or the second aspect.

In a seventh aspect, a communication apparatus is provided in the disclosure. The communication apparatus includes a processor, a memory, and a transceiver. The transceiver is configured to receive a signal or transmit the signal. The memory is configured to store program codes. The processor is configured to invoke the program codes stored in the memory, so as to perform the method in the first aspect or the second aspect and the method in any one of possible embodiments of the first aspect or the second aspect.

In an eighth aspect, a chip is provided in the disclosure. The chip is configured to determine a first time-domain resource unavailable for a PUSCH repetition type B transmission, when a time-domain resource for the PUSCH repetition type B transmission overlaps an idle period in a fixed frame period for channel occupancy by a network device, and the terminal device is unable to transmit an uplink channel in the idle period. The chip is further configured to segment the time-domain resource for the PUSCH repetition type B transmission into a second time-domain resource and a third time-domain resource based on the first time-domain resource, where the second time-domain resource is located before the first time-domain resource and the third time-domain resource is located after the first time-domain resource.

In a ninth aspect, a chip is provided in the disclosure. The chip is configured to pad a target slot symbol, where the target slot symbol is a slot symbol between two adjacent PUSCH transmissions in one or more PUSCH transmissions, or the target slot symbol is a slot symbol before a first PUSCH transmission in the one or more PUSCH transmissions, or the target slot symbol is a slot symbol after a last PUSCH transmission in the one or more PUSCH transmissions; where the multiple PUSCH transmissions are obtained by segmenting a PUSCH and a PUSCH repetition transmission.

In a tenth aspect, a module device is provided in the disclosure. The module device includes a communication module, a power module, a storage module, and a chip module. The power module is configured to supply power to the module device. The storage module is configured to store data and instructions. The communication module is configured to perform internal communication in the module device or configured to perform communication between the module device and an external device. The chip module is configured to determine a first time-domain resource unavailable for a PUSCH repetition type B transmission, when a time-domain resource for the PUSCH repetition type B transmission overlaps an idle period in a fixed frame period for channel occupancy by a network device, and the terminal device is unable to transmit an uplink channel in the idle period; segment the time-domain resource for the PUSCH repetition type B transmission into a second time-domain resource and a third time-domain resource based on the first time-domain resource, where the second time-domain resource is located before the first time-domain resource and the third time-domain resource is located after the first time-domain resource.

In an eleventh aspect, a module device is provided in the disclosure. The module device includes a communication module, a power module, a storage module, and a chip module. The power module is configured to supply power to the module device. The storage module is configured to store data and instructions. The communication module is configured to perform internal communication in the module device or configured to perform communication between the module device and an external device. The chip module is configured to pad a target slot symbol, where the target slot symbol is a slot symbol between two adjacent PUSCH transmissions in one or more PUSCH transmissions, or the target slot symbol is a slot symbol before a first PUSCH transmission in the one or more PUSCH transmissions, or the target slot symbol is a slot symbol after a last PUSCH transmission in the one or more PUSCH transmissions; where the multiple PUSCH transmissions are obtained by segmenting a PUSCH and a PUSCH repetition transmission.

In a twelfth aspect, a computer-readable storage medium is provided in the disclosure. The computer-readable storage medium is configured to store computer-readable instructions, which, when executed by a communication apparatus, are operable with the communication apparatus to perform the method in the first aspect or the second aspect and the method in any one of possible embodiments of the first aspect or the second aspect.

In a thirteenth aspect, a computer program or a computer program product is provided in the disclosure. The computer program or the computer program product includes codes or instructions, which, when executed by a computer, are operable with the computer to perform the method in the first aspect or the second aspect.

Embodiments of the disclosure are applicable to a schematic diagram of a network architecture illustrated in FIG. 2. The network architecture illustrated in FIG. 2 is a network architecture of a wireless communication system. Generally, the network architecture includes a terminal device and a network device, and the number (quantity) and form of each device do not constitute a limitation to the embodiments of the disclosure. The network device may be a base station (BS). The BS can provide communication services for multiple terminal devices, and multiple BSs can also provide communication services for the same terminal device.

It is to be noted that, the wireless communication system in embodiments of the disclosure includes, but is not limited to, a narrow band-internet of things (NB-IoT) system, an enhanced machine type of communication (eMTC) system, a global system for mobile communications (GSM), an enhanced data rate for GSM evolution (EDGE) system, a wideband code division multiple access (WCDMA) system, a code division multiple access 2000 (CDMA2000) system, a time division-synchronization code division multiple access (TD-SCDMA) system, a long term evolution (LTE) system, an LTE Cat1 system, a 5th-generation (5G) system, and a future mobile communication system.

The terminal device involved in embodiments of the disclosure may also be referred to as a terminal, and may be a device with wireless transceiving functions. The terminal device may be deployed on land, including indoor or outdoor, handheld or vehicle-mounted; on water (e.g., a ship); and also in the air (e.g., aircraft, balloons, and satellites). The terminal device may be a user equipment (UE). The UE includes a handheld device with wireless communication functions, an in-vehicle device, a wearable device, or a computing device. Exemplarily, the UE may be a mobile phone, a pad, or a computer with wireless transceiving functions. The terminal device may also be a virtual reality (VR) terminal device, an augmented reality (AR) terminal device, a wireless terminal in industrial control, a wireless terminal in self driving, a wireless terminal in remote medical, a wireless terminal in smart grid, a wireless terminal in a smart city, a wireless terminal in smart home, or the like. In embodiments of the disclosure, an apparatus for implementing a function of a terminal may be the terminal; and may also be an apparatus that can support the terminal to implement the function, for example, a system-on-chip (SOC), which can be installed in the terminal. In embodiments of the disclosure, the SOC may be consisted of a chip, or of a chip and other discrete devices.

The network device involved in embodiments of the disclosure includes the BS, and may be a device that is deployed in a radio access network (RAN) and that can perform wireless communication with the terminal. The BS may have various forms, for example, a macro BS, a micro BS, a relay station, an access point (AP), or the like. Exemplarily, the BS involved in embodiments of the disclosure may be an evolved Node B (eNB). In embodiments of the disclosure, an apparatus for implementing a function of a network device may be the network device; and may also be an apparatus that can support the network device to implement the function, for example, an SOC, which can be installed in the network device.

It is to be noted that, in new radio (NR) standard release 16 (R16), in order to support an ultra reliability and low latency communication (URLLC) scenario, a physical uplink shared channel (PUSCH) repetition type B is supported, which can satisfy a requirement for URLLC latency and can also enhance reliability of a URLLC service. PUSCH repetition type B transmission may occur in one slot or over slots. The BS notifies the terminal device of the number of nominal repetition transmissions via the number of repetitions configured in a time-domain resource table. As illustrated in FIG. 3, FIG. 3 is a schematic diagram illustrating a repetition transmission in the same slot, in which one repetition transmission consists of four slot symbols, the number of nominal repetition transmissions is two, and the number of actual repetition transmissions is two. When the one repetition transmission occurs over slots or at an uplink/downlink switching point, the one repetition transmission is segmented into multiple actual repetition transmissions, and the number of actual repetition transmissions may be greater than the number of nominal repetition transmissions. As illustrated in FIG. 4, FIG. 4 is a schematic diagram illustrating a repetition transmission over slots, in which one repetition transmission consists of four slot symbols, the number of nominal repetition transmissions is two, and the number of actual repetition transmissions is five. If there is only one slot symbol in the segmented repetition transmission, the slot symbol cannot be transmitted, that is, the slot symbol is empty. In addition, for a repetition transmission scheduled by downlink control information (DCI) (including activation DCI), the DCI indicates time-domain resource allocation for a first nominal repetition transmission.

Currently, a protocol merely supports initial channel-occupancy of the BS, but does not support initial channel-occupancy of the terminal device. Since the terminal device needs to perform data transmission in some cases, the initial channel-occupancy of the terminal device is studied. If higher-layer signaling of the BS indicates that the terminal device cannot transmit an uplink channel or a signal in an idle period in a fixed frame period for channel occupancy by the BS, and a duration for the PUSCH repetition type B transmission overlaps the idle period in the fixed frame period for channel occupancy by the BS, the terminal device cannot transmit the uplink channel despite successful channel access, thereby affecting the PUSCH repetition type B transmission of the terminal device.

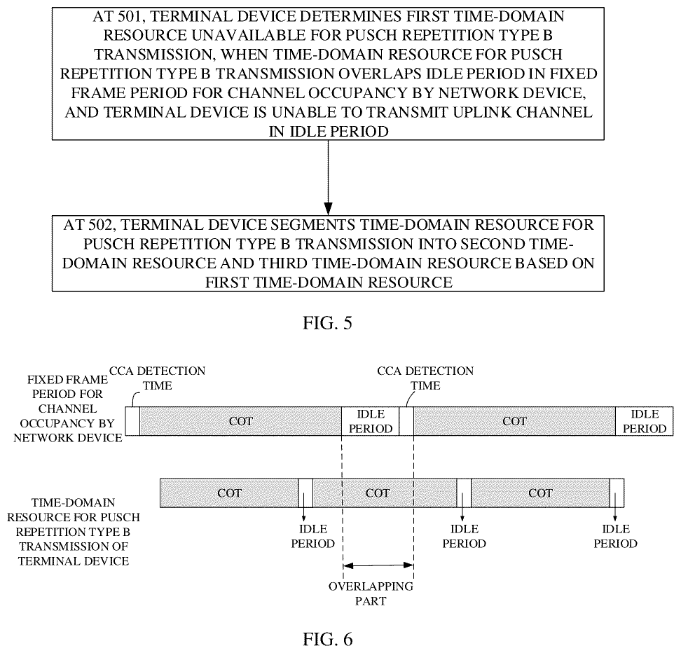

A method for uplink channel transmission provided in embodiments of the disclosure will be introduced in the following based on the network architecture and the device introduced in the foregoing. Reference is made to FIG. 5, where FIG. 5 is a flowchart of a method for uplink channel transmission provided in embodiments of the disclosure. The method for uplink channel transmission includes operations at 501 and at 502. An execution body of the method illustrated in FIG. 5 may be a terminal device, or a chip in the terminal device. The terminal device is taken as an example of the execution body of the method illustrated in FIG. 5.

At 501, a terminal device determines a first time-domain resource unavailable for a PUSCH repetition type B transmission, when a time-domain resource for the PUSCH repetition type B transmission overlaps an idle period in a fixed frame period for channel occupancy by a network device, and the terminal device is unable to transmit an uplink channel in the idle period.

In embodiments of the disclosure, higher-layer signaling of the network device indicates that the terminal device cannot transmit the uplink channel or a signal in the idle period in the fixed frame period for channel occupancy by the network device. Based on the method, it facilitates subsequent processing of the first time-domain resource for the PUSCH repetition type B transmission.

FIG. 6 is a schematic diagram illustrating channel occupancy, respectively, by a terminal device and a network device provided in embodiments of the disclosure. Refer to FIG. 6, the fixed frame period for channel occupancy by the network device includes channel occupancy time (COT) of the network device and the idle period in the fixed frame period. In the idle period in the fixed frame period, a clear channel assessment (CCA) detection can also be performed, so as to determine a current channel state. A fixed frame period of a PUSCH repetition type B transmission of the terminal device includes COT of the terminal device and an idle period in the fixed frame period. As illustrated in FIG. 6, there is an overlapping part of the time-domain resource for the PUSCH repetition type B transmission of the terminal device and the idle period in the fixed frame period for channel occupancy by the network device.

The terminal device determines the first time-domain resource unavailable for the PUSCH repetition type B transmission in the following two modes.
Mode 1: the terminal device determines the idle period as the first time-domain resource unavailable for the PUSCH repetition type B transmission. That is, the terminal device itself can determine the first time-domain resource unavailable for the PUSCH repetition type B transmission. In a possible embodiment, the first time-domain resource unavailable for the PUSCH repetition type B transmission has the same length as the idle period in the fixed frame period for channel occupancy by the network device. Based on this mode, the terminal device itself determines a time-domain resource unavailable for the PUSCH repetition type B transmission without a need for an indication from the network device, which is conducive to reducing signaling overhead.
Mode 2: the terminal device receives second indication information from the network device, where the second indication information indicates the time-domain resource unavailable for the PUSCH repetition type B transmission. The terminal device determines the first time-domain resource unavailable for the PUSCH repetition type B transmission based on the second indication information. That is, the time-domain resource unavailable for the PUSCH repetition type B transmission is determined by the network device and notified to the terminal device. For a specific embodiment of Mode 2, reference can be made to the illustration of FIG. 13, which will not be repeated herein.

At 502, the terminal device segments the time-domain resource for the PUSCH repetition type B transmission into a second time-domain resource and a third time-domain resource based on the first time-domain resource.

In embodiments of the disclosure, the second time-domain resource is located before the first time-domain resource, and the third time-domain resource is located after the first time-domain resource. Based on the method, the time-domain resource for the PUSCH repetition type B transmission can be segmented, when higher-layer signaling of the network device indicates that the terminal device cannot transmit the uplink channel or the signal in the idle period in the fixed frame period for channel occupancy by the network device, and a duration for the PUSCH repetition type B transmission overlaps the idle period in the fixed frame period for channel occupancy by the network device.

In the method illustrated in FIG. 5, the terminal device determines the time-domain resource unavailable for the PUSCH repetition type B transmission, and segments the time-domain resource for the PUSCH repetition type B transmission into the second time-domain resource and the third time-domain resource based on the time-domain resource unavailable for the PUSCH repetition type B transmission, so that the terminal device can subsequently perform the PUSCH repetition type B transmission in the second time-domain resource and in the third time-domain resource. Therefore, based on the method illustrated in FIG. 5, it is conducive to avoiding a PUSCH repetition type B transmission failure.

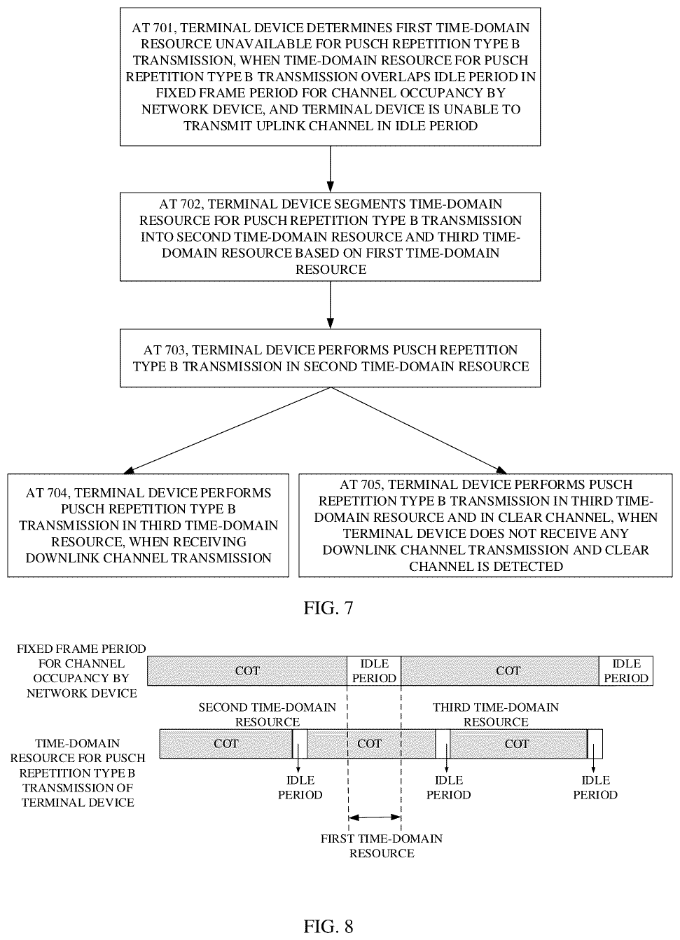

Referring to FIG. 7 which is a flowchart of another method for uplink channel transmission provided in embodiments of the disclosure, the method for uplink channel transmission includes operations at 701 to operations at 705. An execution body of the method illustrated in FIG. 7 may be a terminal device, or a chip in the terminal device. The terminal device is taken as an example of the execution body of the method illustrated in FIG. 7.

At 701, a terminal device determines a first time-domain resource unavailable for a PUSCH repetition type B transmission, when a time-domain resource for the PUSCH repetition type B transmission overlaps an idle period in a fixed frame period for channel occupancy by a network device, and the terminal device is unable to transmit an uplink channel in the idle period.

At 702, the terminal device segments the time-domain resource for the PUSCH repetition type B transmission into a second time-domain resource and a third time-domain resource based on the first time-domain resource.

Specific embodiments of operations at 701 and operations at 702 are the same as the specific embodiments of operations at 501 and operations at 502, which will not be repeated herein.

FIG. 8 is a schematic diagram illustrating segmentation of a time-domain resource for a PUSCH repetition transmission provided in embodiments of the disclosure. As illustrated in FIG. 8, the idle period in the fixed frame period for channel occupancy by the network device is an overlapping part of the time-domain resource for the PUSCH repetition type B transmission and the idle period in the fixed frame period for channel occupancy by the network device, that is, the idle period in the fixed frame period for channel occupancy by the network device is the first time-domain resource unavailable for the PUSCH repetition type B transmission. The time-domain resource for the PUSCH repetition type B transmission is segmented based on the first time-domain resource, where the second time-domain resource is located before the first time-domain resource, and the third time-domain resource is located after the first time-domain resource.

At 703, the terminal device performs the PUSCH repetition type B transmission in the second time-domain resource.

At 704, the terminal device performs the PUSCH repetition type B transmission in the third time-domain resource, when receiving a downlink channel transmission.

In embodiments of the disclosure, after performing the PUSCH repetition type B transmission in the second time-domain resource, the terminal device determines that the channel is occupied by the network device and that the second time-domain resource is not in the idle period in the fixed frame period, when receiving the downlink channel transmission, and therefore, the terminal device can continue to perform the PUSCH repetition type B transmission in the third time-domain resource. Based on the method, it is conducive to avoiding a PUSCH repetition type B transmission failure.

At 705, the terminal device performs the PUSCH repetition type B transmission in the third time-domain resource and in a clear channel, when the terminal device does not receive any downlink channel transmission and the clear channel is detected.

In embodiments of the disclosure, after performing the PUSCH repetition type B transmission in the second time-domain resource, the terminal device monitors a current channel when not receiving any downlink channel transmission, and performs the PUSCH repetition type B transmission in the third time-domain resource and in the channel only when the channel is in an idle state. Based on the method, it is conducive to avoiding a PUSCH repetition type B transmission failure.

In a possible embodiment, the terminal pads a target slot symbol when the target slot symbol exists. In the possible embodiment, the target slot symbol is a slot symbol between the first time-domain resource and the second time-domain resource, or the target slot symbol is a slot symbol between the first time-domain resource and the third time-domain resource, or the target slot symbol is a slot symbol before or after a slot boundary in the second time-domain resource, or the target slot symbol is a slot symbol before or after a slot boundary in the third time-domain resource. Based on the method, it is conducive to preventing the terminal device in unlicensed spectrum from re-accessing a channel due to an orphan slot symbol being empty for a long time.

It is to be noted that, the target slot symbol does not belong to a next PUSCH repetition type B transmission, and a length of the next PUSCH repetition type B transmission is still a length configured by DCI or higher-layer signaling.

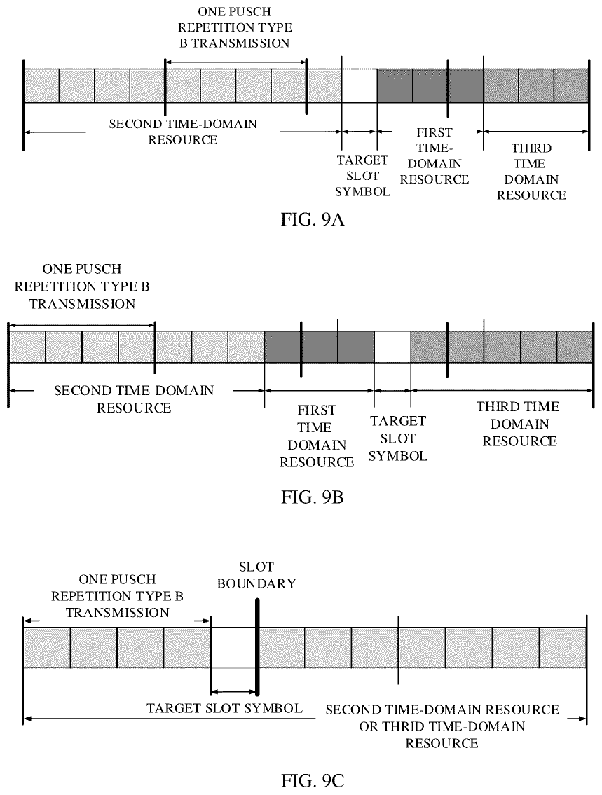

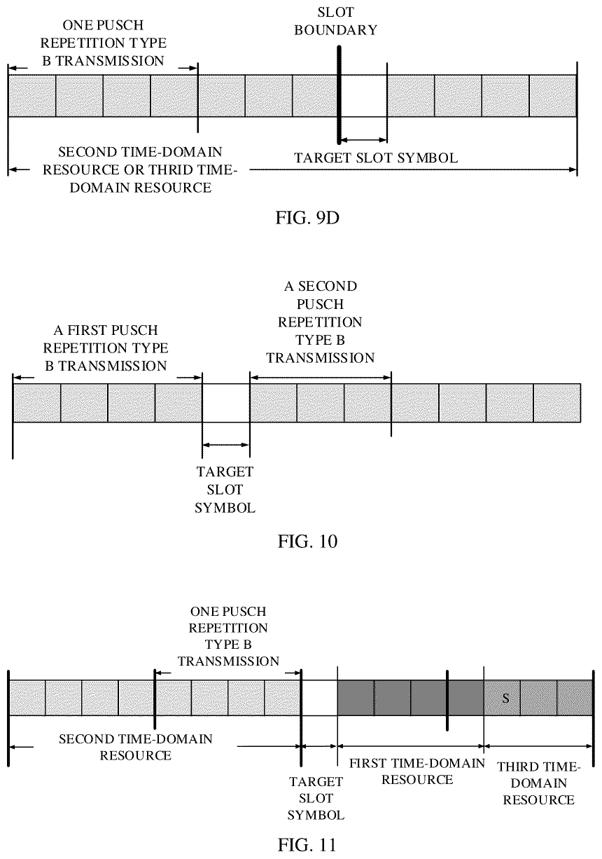

For example, FIG. 9A is a schematic diagram of a target slot symbol provided in embodiments of the disclosure, where the target slot symbol is the slot symbol between the first time-domain resource and the second time-domain resource. One PUSCH repetition type B transmission consists of four slot symbols.

For another example, FIG. 9B is a schematic diagram of another target slot symbol provided in embodiments of the disclosure, where the target slot symbol is the slot symbol between the first time-domain resource and the third time-domain resource. One PUSCH repetition type B transmission consists of four slot symbols.

For another example, FIG. 9C is a schematic diagram of yet another target slot symbol provided in embodiments of the disclosure, where the target slot symbol is the slot symbol before the slot boundary in the second time-domain resource or the slot symbol before the slot boundary in the third time-domain resource. One PUSCH repetition type B transmission consists of four slot symbols.

For another example, FIG. 9D is a schematic diagram of yet another target slot symbol provided in embodiments of the disclosure, where the target slot symbol is the slot symbol after the slot boundary in the second time-domain resource or the slot symbol after the slot boundary in the third time-domain resource. One PUSCH repetition type B transmission consists of four slot symbols.

In a possible embodiment, before the terminal device segments the time-domain resource for the PUSCH repetition type B transmission into the second time-domain resource and the third time-domain resource based on the first time-domain resource, the method includes the following. The terminal device pads a target slot symbol when the target slot symbol exists, where the target slot symbol is a slot symbol between two adjacent PUSCH transmissions in one or more PUSCH transmissions, or the target slot symbol is a slot symbol before a first PUSCH transmission in the one or more PUSCH transmissions, or the target slot symbol is a slot symbol after a last PUSCH transmission in the one or more PUSCH transmissions; where the multiple PUSCH transmissions are obtained by segmenting a PUSCH and the PUSCH repetition type B transmission.

For example, FIG. 10 is a schematic diagram of yet another target slot symbol provided in embodiments of the disclosure, where the target slot symbol is the slot symbol between the two adjacent PUSCH transmissions. One PUSCH repetition type B transmission consists of four slot symbols. A second PUSCH repetition type B transmission is obtained by segmenting the PUSCH repetition type B transmission.

In a possible embodiment, the terminal device pads the target slot symbol by using an extended cyclic prefix (CP) of a first slot symbol in the third time-domain resource, when the target slot symbol is the slot symbol between the first time-domain resource and the second time-domain resource, or the target slot symbol is the slot symbol between the first time-domain resource and the third time-domain resource. Based on the method, the terminal device does not have to generate new data to pad an orphan slot symbol, which can make a method for orphan slot symbol padding simpler.

For example, FIG. 11 is a schematic diagram illustrating target slot symbol padding provided in embodiments of the disclosure. As illustrated in FIG. 11, the target slot symbol is the slot symbol between the first time-domain resource and the second time-domain resource, and a first slot symbol in the third time-domain resource is a slot symbol S. Therefore, the target slot symbol is padded by using an extended CP of the slot symbol S.

In a possible embodiment, the terminal device pads the target slot symbol by using an extended CP of a next slot symbol to the target slot symbol. Alternatively, the terminal device pads the target slot symbol by using an extended CP of a previous slot symbol to the target slot symbol. Based on the method, the terminal device does not have to generate new data to pad an orphan slot symbol, which can make a method for orphan slot symbol padding simpler.

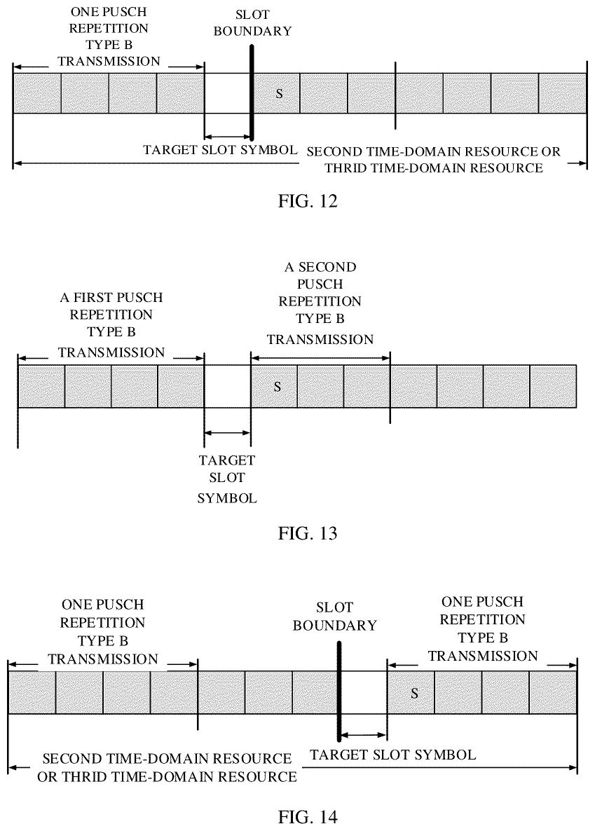

For example, FIG. 12 is a schematic diagram illustrating another target slot symbol padding provided in embodiments of the disclosure. As illustrated in FIG. 12, the target slot symbol is the slot symbol before the slot boundary in the second time-domain resource or the slot symbol before the slot boundary in the third time-domain resource, and a next slot symbol to the target slot symbol is a slot symbol S. Therefore, the target slot symbol is padded by using an extended CP of the slot symbol S.

For another example, FIG. 13 is schematic diagram illustrating yet another target slot symbol padding provided in embodiments of the disclosure. As illustrated in FIG. 13, the target slot symbol is the slot symbol between the two adjacent PUSCH transmissions, and a next slot symbol to the target slot symbol is a slot symbol S. Therefore, the target slot symbol is padded by using an extended CP of the slot symbol S.

In a possible embodiment, the terminal device pads the target slot symbol by using data in a first slot symbol for a next PUSCH repetition type B transmission. Alternatively, the terminal device pads the target slot symbol by using data in a last slot symbol for a previous PUSCH repetition type B transmission. Based on the method, the terminal device does not have to generate new data to pad an orphan slot symbol, which can make a method for orphan slot symbol padding simpler.

For example, FIG. 14 is a schematic diagram illustrating yet another target slot symbol padding provided in embodiments of the disclosure. As illustrated in FIG. 14, the target slot symbol is the slot symbol after the slot boundary in the second time-domain resource or the slot symbol after the slot boundary in the third time-domain resource, and a first slot symbol for a next PUSCH repetition type B transmission is a slot symbol S. Therefore, the target slot symbol is padded by using data in the slot symbol S.

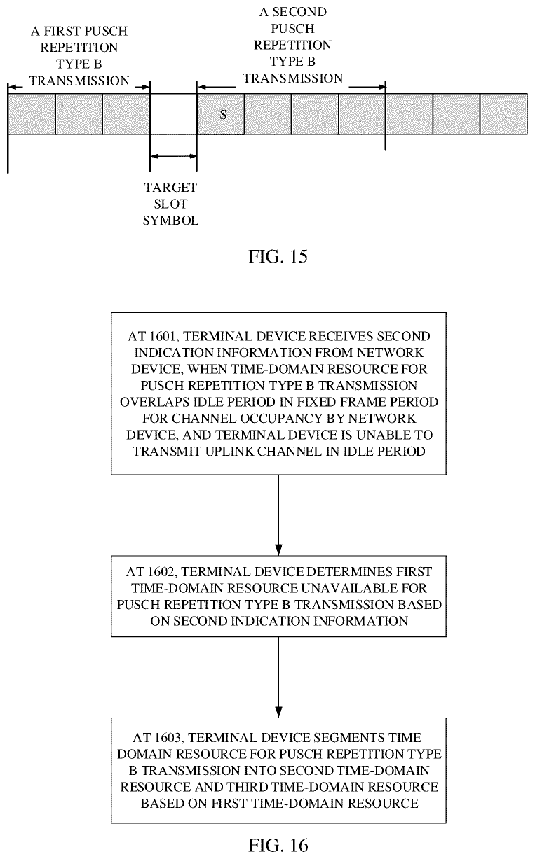

For another example, FIG. 15 is a schematic diagram illustrating yet another target slot symbol padding provided in embodiments of the disclosure. As illustrated in FIG. 15, the target slot symbol is the slot symbol between the two adjacent PUSCH transmissions, and a first slot symbol for a next PUSCH repetition type B transmission is a slot symbol S. Therefore, the target slot symbol is padded by using data in the slot symbol S.

In the method illustrated in FIG. 7, the terminal device determines the time-domain resource unavailable for the PUSCH repetition type B transmission, and segments the time-domain resource for the PUSCH repetition type B transmission into the second time-domain resource and the third time-domain resource based on the time-domain resource unavailable for the PUSCH repetition type B transmission. Therefore, based on the method illustrated in FIG. 7, it is conducive to avoiding a PUSCH repetition type B transmission failure.

Referring to FIG. 16 which is a flowchart of yet another method for uplink channel transmission provided in embodiments of the disclosure, the method for uplink channel transmission includes operations at 1601 to operations at 1603. Operations at 1601 and operations at 1602 are respectively a specific embodiment of operations at 501. An execution body of the method illustrated in FIG. 16 may be a terminal device, or a chip in the terminal device. The terminal device is taken as an example of the execution body of the method illustrated in FIG. 16.

At 1601, a terminal device receives second indication information from a network device, when a time-domain resource for a PUSCH repetition type B transmission overlaps an idle period in a fixed frame period for channel occupancy by a network device, and the terminal device is unable to transmit an uplink channel in the idle period.

In embodiments of the disclosure, the second indication information indicates a time-domain resource unavailable for the PUSCH repetition type B transmission. The second indication information is configured by the network device based on the fixed frame period for channel occupancy by the network device, the idle period in the fixed frame period for channel occupancy by the network device, the time-domain resource for the PUSCH repetition type B transmission of the terminal device, an idle period of the PUSCH repetition type B transmission of the terminal device, time of uplink/downlink switching, and the like. Based on the method, it is conducive to enhancing flexibility of scheduling of the network device.

Optionally, a length of the time-domain resource unavailable for the PUSCH repetition type B transmission is configured by the network device, and the length of the time-domain resource unavailable for the PUSCH repetition type B transmission may be equal to or greater than the length of the idle period in the fixed frame period for channel occupancy by the network device.

For example, the idle period in the fixed frame period for channel occupancy by the network device consists of four slot symbols, and the time-domain resource unavailable for the PUSCH repetition type B transmission may consist of four or more slot symbols.

At 1602, the terminal device determines a first time-domain resource unavailable for the PUSCH repetition type B transmission based on the second indication information.

In embodiments of the disclosure, the terminal device determines the first time-domain resource unavailable for the PUSCH repetition type B transmission according to the second indication information, which facilitates subsequent processing of the time-domain resource for the PUSCH repetition type B transmission. Based on the method, it is conducive to enhancing flexibility of configuration for the time-domain resource unavailable for the PUSCH repetition type B transmission.

At 1603, the terminal device segments the time-domain resource for the PUSCH repetition type B transmission into a second time-domain resource and a third time-domain resource based on the first time-domain resource.

A specific embodiment of operations at 1603 is the same as the specific embodiment of operations at 502, which will not be repeated herein.

In the method illustrated in FIG. 16, the terminal device determines the time-domain resource unavailable for the PUSCH repetition type B transmission, and segments the time-domain resource for the PUSCH repetition type B transmission into the second time-domain resource and the third time-domain resource based on the time-domain resource unavailable for the PUSCH repetition type B transmission, so that the terminal device can subsequently perform the PUSCH repetition type B transmission in the second time-domain resource and in the third time-domain resource. Therefore, based on the method illustrated in FIG. 16, it is conducive to avoiding a PUSCH repetition type B transmission failure.

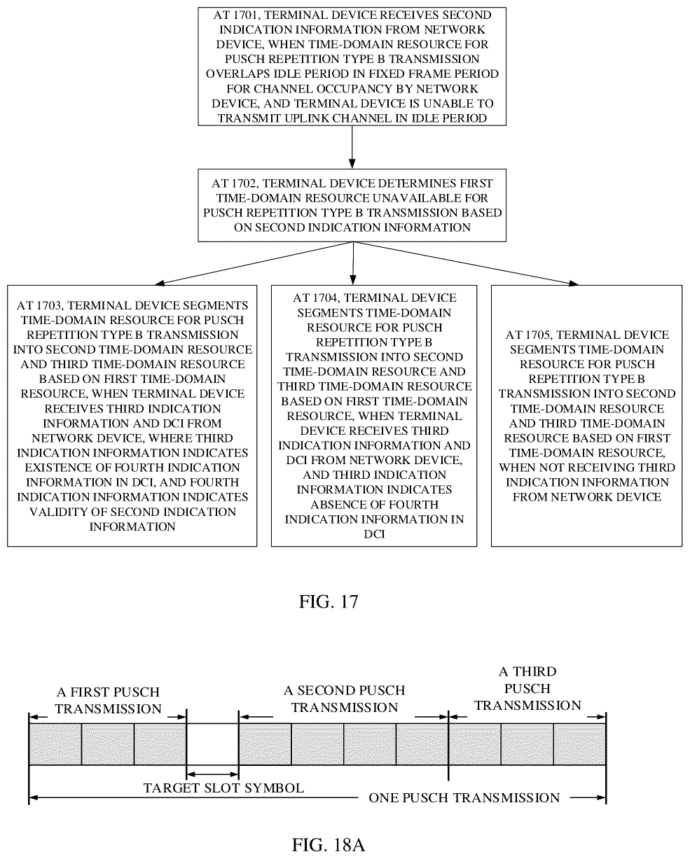

Referring to FIG. 17 which is a flowchart of yet another method for uplink channel transmission provided in embodiments of the disclosure, the method for uplink channel transmission includes operations at 1701 to operations at 1705. Operations at 1703, operations at 1704, and operations at 1705 are respectively a specific embodiment of operations at 1603. An execution body of the method illustrated in FIG. 17 may be a terminal device, or a chip in the terminal device. The terminal device is taken as an example of the execution body of the method illustrated in FIG. 17.

At 1701, a terminal device receives second indication information from a network device, when a time-domain resource for a PUSCH repetition type B transmission overlaps an idle period in a fixed frame period for channel occupancy by a network device, and the terminal device is unable to transmit an uplink channel in the idle period.

At 1702, the terminal device determines a first time-domain resource unavailable for the PUSCH repetition type B transmission based on the second indication information.

Specific embodiments of operations at 1701 and operations at 1702 are the same as the specific embodiments of operations at 1601 and operations at 1602, which will not be repeated herein.

At 1703, the terminal device segments the time-domain resource for the PUSCH repetition type B transmission into a second time-domain resource and a third time-domain resource based on the first time-domain resource, when the terminal device receives third indication information and DCI from the network device, where the third indication information indicates existence of fourth indication information in the DCI, and the fourth indication information indicates validity of the second indication information.

The PUSCH repetition type B transmission is a dynamically scheduled PUSCH repetition transmission or a scheduled and granted PUSCH repetition transmission activated by a physical downlink control channel (PDCCH). The second time-domain resource is located before the first time-domain resource, and the third time-domain resource is located after the first time-domain resource.

In embodiments of the disclosure, the third indication information indicates whether the fourth indication information exists in the DCI, and the fourth indication information indicates whether the second indication information is valid. Based on the method, it is conducive to enhancing flexibility of scheduling of the network device.

At 1704, the terminal device segments the time-domain resource for the PUSCH repetition type B transmission into the second time-domain resource and the third time-domain resource based on the first time-domain resource, when the terminal device receives the third indication information and the DCI from the network device, and the third indication information indicates absence of the fourth indication information in the DCI.

In embodiments of the disclosure, the PUSCH repetition type B transmission is the dynamically scheduled PUSCH repetition transmission or the scheduled and granted PUSCH repetition transmission activated by the PDCCH. Based on the method, it is conducive to enhancing flexibility of scheduling of the network device.

At 1705, the terminal device segments the time-domain resource for the PUSCH repetition type B transmission into the second time-domain resource and the third time-domain resource based on the first time-domain resource, when not receiving third indication information from the network device.

The PUSCH repetition type B transmission is the scheduled and granted PUSCH repetition transmission activated by the PDCCH. The second time-domain resource is located before the first time-domain resource, and the third time-domain resource is located after the first time-domain resource.

In embodiments of the disclosure, the third indication information indicates whether the fourth indication information exists in the DCI, and the fourth indication information indicates whether the second indication information is valid. Based on the method, it is conducive to enhancing flexibility of scheduling of the network device.

In the method illustrated in FIG. 17, the terminal device determines the time-domain resource unavailable for the PUSCH repetition type B transmission, and segments the time-domain resource for the PUSCH repetition type B transmission into the second time-domain resource and the third time-domain resource based on the time-domain resource unavailable for the PUSCH repetition type B transmission, so that the terminal device can subsequently perform the PUSCH repetition type B transmission in the second time-domain resource and in the third time-domain resource. Therefore, based on the method illustrated in FIG. 17, it is conducive to avoiding a PUSCH repetition type B transmission failure.

A method for slot symbol padding is provided in embodiments of the disclosure. An execution body of the method may be a terminal device, or a chip in the terminal device. The terminal device is taken as an example of the execution body of the method. Specifically, the method includes the following. The terminal device pads a target slot symbol, where the target slot symbol is a slot symbol between two adjacent PUSCH transmissions in one or more PUSCH transmissions, or the target slot symbol is a slot symbol before a first PUSCH transmission in the one or more PUSCH transmissions, or the target slot symbol is a slot symbol after a last PUSCH transmission in the one or more PUSCH transmissions; where the multiple PUSCH transmissions are obtained by segmenting a PUSCH and a PUSCH repetition transmission.

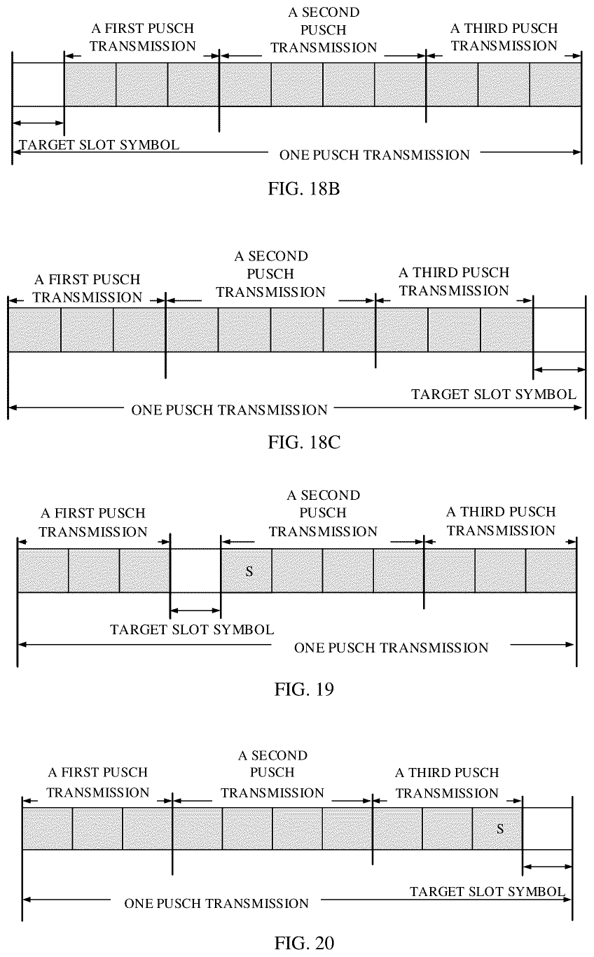

For example, FIG. 18A is a schematic diagram of yet another target slot symbol provided in embodiments of the disclosure, where the target slot symbol is a slot symbol between a first PUSCH transmission and a second PUSCH transmission in three PUSCH transmissions. One PUSCH transmission consists of 11 slot symbols and is segmented into the three PUSCH transmissions. The first PUSCH transmission consists of three slot symbols, the second PUSCH transmission consists of four slot symbols, and a third PUSCH transmission consists of three slot symbols.

For another example, FIG. 18B is a schematic diagram of yet another target slot symbol provided in embodiments of the disclosure, where the target slot symbol is a slot symbol before a first PUSCH transmission in three PUSCH transmissions. One PUSCH transmission consists of 11 slot symbols and is segmented into the three PUSCH transmissions. The first PUSCH transmission consists of three slot symbols, a second PUSCH transmission consists of four slot symbols, and a third PUSCH transmission consists of three slot symbols.

For another example, FIG. 18C is a schematic diagram of yet another target slot symbol provided in embodiments of the disclosure, where the target slot symbol is a slot symbol after a last PUSCH transmission in three PUSCH transmissions. One PUSCH transmission consists of 11 slot symbols and is segmented into the three PUSCH transmission. A first PUSCH transmission consists of three slot symbols, a second PUSCH transmission consists of four slot symbols, and a third PUSCH transmission consists of three slot symbols.

In a possible embodiment, the terminal device pads the target slot symbol as follows. The terminal device pads the target slot symbol by using an extended CP of a next slot symbol to the target slot symbol. Based on the method, the terminal device does not have to generate new data to pad an orphan slot symbol, which can make a method for orphan slot symbol padding simpler.

For example, FIG. 19 is a schematic diagram illustrating yet another target slot symbol padding provided in embodiments of the disclosure. As illustrated in FIG. 19, the target slot symbol is a slot symbol between two adjacent PUSCH transmissions in multiple PUSCH transmissions, and a next slot symbol to the target slot symbol is a slot symbol S. Therefore, the target slot symbol is padded by using an extended CP of the slot symbol S.

In a possible embodiment, the terminal device pads the target slot symbol as follows. The terminal device pads the target slot symbol by using an extended CP of a previous slot symbol to the target slot symbol. Based on the method, the terminal device does not have to generate new data to pad an orphan slot symbol, which can make a method for orphan slot symbol padding simpler.

For example, FIG. 20 is a schematic diagram illustrating yet another target slot symbol padding provided in embodiments of the disclosure. As illustrated in FIG. 20, the target slot symbol is a slot symbol after a last PUSCH transmission in one or more PUSCH transmissions, and a next slot symbol to the target slot symbol is absent. Therefore, the target slot symbol is padded by using an extended CP of a previous slot symbol S to the target slot symbol.

In a possible embodiment, the terminal device pads the target slot symbol as follows. The terminal device pads the target slot symbol by using data in a first slot symbol for a next PUSCH repetition transmission. Based on the method, the terminal device does not have to generate new data to pad an orphan slot symbol, which can make a method for orphan slot symbol padding simpler.

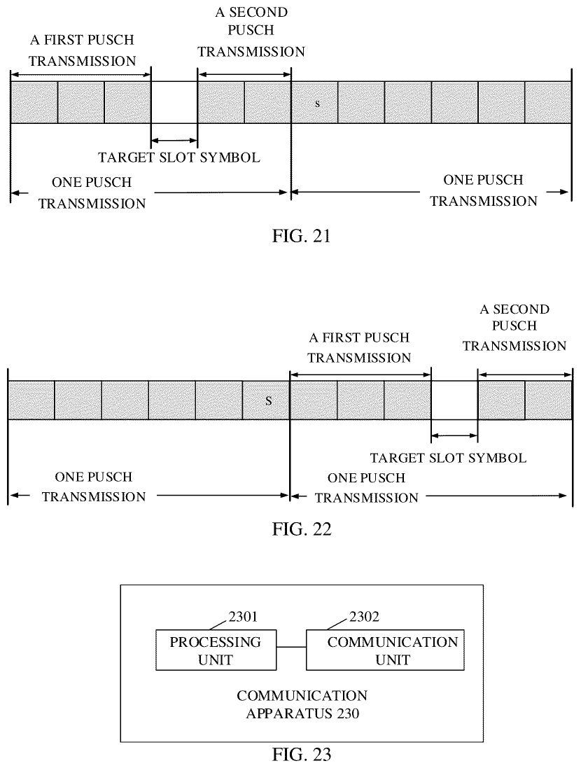

For example, FIG. 21 is a schematic diagram illustrating yet another target slot symbol padding provided in embodiments of the disclosure. As illustrated in FIG. 21, the target slot symbol is a slot symbol between two adjacent PUSCH transmissions in multiple PUSCH transmissions, and a first slot symbol for a next PUSCH repetition transmission is a slot symbol S. Therefore, the target slot symbol is padded by using data in the slot symbol S.

In a possible embodiment, the terminal device pads the target slot symbol as follows. The terminal device pads the target slot symbol by using data in a last slot symbol for a previous PUSCH repetition transmission. Based on the method, the terminal device does not have to generate new data to pad an orphan slot symbol, which can make a method for orphan slot symbol padding simpler.

For example, FIG. 22 is a schematic diagram illustrating yet another target slot symbol padding provided in embodiments of the disclosure. As illustrated in FIG. 22, the target slot symbol is a slot symbol between two adjacent PUSCH transmissions in multiple PUSCH transmissions, and a next PUSCH repetition transmission does not exist. Therefore, the target slot symbol is padded by using data in a last slot symbol S for a previous PUSCH repetition transmission.

Reference is made to FIG. 23, where FIG. 23 illustrates a schematic structural diagram of a communication apparatus in embodiments of the disclosure. The apparatus may be a terminal device, or an apparatus in the terminal device, or an apparatus that can be used cooperatively with the terminal device. The communication apparatus illustrated in FIG. 23 may include a processing unit 2301 and a communication unit 2302. The processing unit 2301 is configured to perform data processing. The communication unit 2302 is integrated with a receiving unit and a transmitting unit. The communication unit 2302 may also be referred to as a transceiving unit. Alternatively, the communication unit 2302 may also be split into the receiving unit and the transmitting unit. The processing unit 2301 below is similar to the communication unit 2302, which will not be repeated in the following.

The processing unit 2301 is configured to determine a first time-domain resource unavailable for a PUSCH repetition type B transmission, when a time-domain resource for the PUSCH repetition type B transmission overlaps an idle period in a fixed frame period for channel occupancy by a network device, and the terminal device is unable to transmit an uplink channel in the idle period.

The processing unit 2301 is further configured to segment the time-domain resource for the PUSCH repetition type B transmission into a second time-domain resource and a third time-domain resource based on the first time-domain resource, where the second time-domain resource is located before the first time-domain resource and the third time-domain resource is located after the first time-domain resource.

Optionally, the processing unit 2301 is further configured to perform the PUSCH repetition type B transmission in the second time-domain resource; and to perform the PUSCH repetition type B transmission in the third time-domain resource when receiving a downlink channel transmission.

Optionally, the processing unit 2301 is further configured to perform the PUSCH repetition type B transmission in the third time-domain resource and in a clear channel when the processing unit 2301 does not receive any downlink channel transmission and the clear channel is detected.

Optionally, the downlink channel transmission is first indication information, and the first indication information indicates to perform the PUSCH repetition type B transmission in the third time-domain resource.

Optionally, the processing unit 2301 is further configured to pad a target slot symbol when the target slot symbol exists, where the target slot symbol is a slot symbol between the first time-domain resource and the second time-domain resource, or the target slot symbol is a slot symbol between the first time-domain resource and the third time-domain resource, or the target slot symbol is a slot symbol before or after a slot boundary in the second time-domain resource, or the target slot symbol is a slot symbol before or after a slot boundary in the third time-domain resource.

Optionally, the processing unit 2301, before segmenting the time-domain resource for the PUSCH repetition type B transmission into the second time-domain resource and the third time-domain resource based on the first time-domain resource, is further configured to pad a target slot symbol when the target slot symbol exists, where the target slot symbol is a slot symbol between two adjacent PUSCH transmissions in one or more PUSCH transmissions, or the target slot symbol is a slot symbol before a first PUSCH transmission in the one or more PUSCH transmissions, or the target slot symbol is a slot symbol after a last PUSCH transmission in the one or more PUSCH transmissions; where the multiple PUSCH transmissions are obtained by segmenting a PUSCH and the PUSCH repetition type B transmission.

Optionally, the target slot symbol is the slot symbol between the first time-domain resource and the second time-domain resource, or the target slot symbol is the slot symbol between the first time-domain resource and the third time-domain resource. The processing unit 2301, configured to pad the target slot symbol, is specifically configured to pad the target slot symbol by using an extended CP of a first slot symbol in the third time-domain resource.

Optionally, the processing unit 2301, configured to pad the target slot symbol, is specifically configured to pad the target slot symbol by using an extended CP of a next slot symbol to the target slot symbol, or pad the target slot symbol by using an extended CP of a previous slot symbol to the target slot symbol.

Optionally, the processing unit 2301, configured to pad the target slot symbol, is specifically configured to pad the target slot symbol by using data in a first slot symbol for a next PUSCH repetition transmission, or pad the target slot symbol by using data in a last slot symbol for a previous PUSCH repetition transmission.

Optionally, the processing unit 2301, configured to determine the first time-domain resource unavailable for the PUSCH repetition type B transmission, is specifically configured to determine the idle period as the first time-domain resource unavailable for the PUSCH repetition type B transmission.

Optionally, the processing unit 2301, configured to determine the first time-domain resource unavailable for the PUSCH repetition type B transmission, is specifically configured to receive second indication information from the network device, where the second indication information indicates a time-domain resource unavailable for the PUSCH repetition type B transmission; and to determine the first time-domain resource unavailable for the PUSCH repetition type B transmission based on the second indication information.

Optionally, the PUSCH repetition type B transmission is a dynamically scheduled PUSCH repetition transmission or a scheduled and granted PUSCH repetition transmission activated by a PDCCH. The processing unit 2301, configured to segment the time-domain resource for the PUSCH repetition type B transmission into the second time-domain resource and the third time-domain resource based on the first time-domain, is specifically configured to segment the time-domain resource for the PUSCH repetition type B transmission into the second time-domain resource and the third time-domain resource based on the first time-domain resource when the processing unit 2301 receives third indication information and DCI from the network device, and the third indication information indicates existence of fourth indication information in the DCI, and the fourth indication information indicates validity of the second indication information; where the third indication information indicates whether the fourth indication information exists in the DCI, and the fourth indication information indicates whether the second indication information is valid.

Optionally, the processing unit 2301 is further configured to segment the time-domain resource for the PUSCH repetition type B transmission into the second time-domain resource and the third time-domain resource based on the first time-domain resource, when the processing unit 2301 receives third indication information and DCI from the network device, and the third indication information indicates absence of fourth indication information in the DCI.

Optionally, the PUSCH repetition type B transmission is a scheduled and granted PUSCH repetition transmission activated by a non-PDCCH. The processing unit 2301, configured to segment the time-domain resource for the PUSCH repetition type B transmission into the second time-domain resource and the third time-domain resource based on the first time-domain, is specifically configured to segment the time-domain resource for the PUSCH repetition type B transmission into the second time-domain resource and the third time-domain resource based on the first time-domain resource when not receiving third indication information from the network device; where the third indication information indicates whether fourth indication information exists in DCI, and the fourth indication information indicates whether the second indication information is valid.

The communication apparatus above may be, for example, a chip or a chip module. For each apparatus and product described in the embodiments above, each module may be a software module, a hardware module, or may be partially a software module and partially a hardware module. For example, for each apparatus and product applied to or integrated into the chip, each module included can be implemented by hardware such as circuits, or at least part of modules can be implemented by software programs that run on a processor integrated into the chip, and the rest (if any) of modules can be implemented by hardware such as circuits. For each apparatus and product applied to or integrated into the chip module, each module included can be implemented by hardware such as circuit, and different modules can be located in a same component (such as a chip, a circuit module, and the like) or different components of the chip module. Alternatively, at least part of modules can be implemented by software programs that run on the processor integrated into the chip module, and the rest (if any) of modules can be implemented by hardware such as circuits. For each apparatus and product applied to or integrated into the UE, each module included can be implemented by hardware such as circuits, and different modules can be located in a same component (such as a chip, a circuit module, and the like) or different components in the UE, or at least part of modules can be implemented by software programs that run on the processor integrated into the UE, and the rest (if any) of modules can be implemented by hardware such as circuits.

Reference is made to FIG. 23, where FIG. 23 illustrates a schematic structural diagram of a communication apparatus in embodiments of the disclosure. The apparatus may be a terminal device, or an apparatus in the terminal device, or an apparatus that can be used cooperatively with the terminal device. The communication apparatus illustrated in FIG. 23 may include a processing unit 2301 and a communication unit 2302. The processing unit 2301 is configured to perform data processing. The communication unit 2302 is integrated with a receiving unit and a transmitting unit. The communication unit 2302 may also be referred to as a transceiving unit. Alternatively, the communication unit 2302 may also be split into the receiving unit and the transmitting unit. The processing unit 2301 below is similar to the communication unit 2302, which will not be repeated in the following.

The processing unit 2301 is configured to pad a target slot symbol, where the target slot symbol is a slot symbol between two adjacent PUSCH transmissions in one or more PUSCH transmissions, or the target slot symbol is a slot symbol before a first PUSCH transmission in the one or more PUSCH transmissions, or the target slot symbol is a slot symbol after a last PUSCH transmission in the one or more PUSCH transmissions; where the multiple PUSCH transmissions are obtained by segmenting a PUSCH and a PUSCH repetition transmission.

Optionally, the processing unit 2301, configured to pad the target slot symbol, is specifically configured to pad the target slot symbol by using an extended CP of a next slot symbol to the target slot symbol.

Optionally, the processing unit 2301, configured to pad the target slot symbol, is specifically configured to pad the target slot symbol by using an extended CP of a previous slot symbol to the target slot symbol.

Optionally, the processing unit 2301, configured to pad the target slot symbol, is specifically configured to pad the target slot symbol by using data in a first slot symbol for a next PUSCH repetition transmission.

Optionally, the processing unit 2301, configured to pad the target slot symbol, is specifically configured to pad the target slot symbol by using data in a last slot symbol for a previous PUSCH repetition transmission.

The communication apparatus above may be, for example, a chip or a chip module. For each apparatus and product described in the embodiments above, each module may be a software module, a hardware module, or may be partially a software module and partially a hardware module. For example, for each apparatus and product applied to or integrated into the chip, each module included can be implemented by hardware such as circuits, or at least part of modules can be implemented by software programs that run on a processor integrated into the chip, and the rest (if any) of modules can be implemented by hardware such as circuits. For each apparatus and product applied to or integrated into the chip module, each module included can be implemented by hardware such as circuit, and different modules can be located in a same component (such as a chip, a circuit module, and the like) or different components of the chip module. Alternatively, at least part of modules can be implemented by software programs that run on the processor integrated into the chip module, and the rest (if any) of modules can be implemented by hardware such as circuits. For each apparatus and product applied to or integrated into the UE, each module included can be implemented by hardware such as circuits, and different modules can be located in a same component (such as a chip, a circuit module, and the like) or different components in the UE, or at least part of modules can be implemented by software programs that run on the processor integrated into the UE, and the rest (if any) of modules can be implemented by hardware such as circuits.

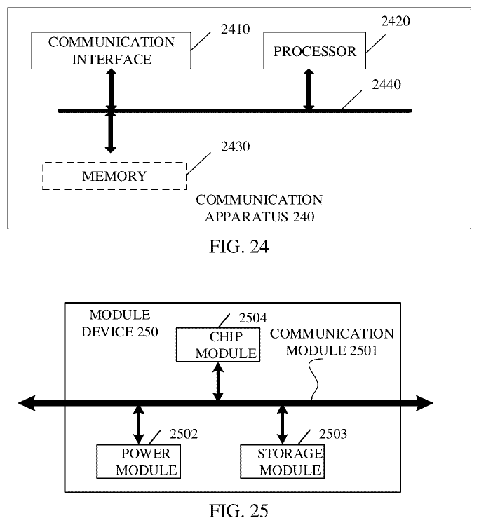

Reference is made to FIG. 24, where FIG. 24 illustrates a schematic structural diagram of yet another communication apparatus in embodiments of the disclosure. As illustrated in FIG. 24, a communication apparatus 240 is provided in embodiments of the disclosure. The communication apparatus 240 is configured to implement the functions performed by the terminal devices in FIG. 5, FIG. 7, FIG. 16, and FIG. 17. The apparatus may be a terminal device or an apparatus configured for the terminal device. The apparatus configured for the terminal device may be an SOC or a chip in the terminal device. The SOC may be consisted of the chip, or of the chip and other discrete devices.

The communication apparatus 240 includes at least one processor 2420. The processor 2420 is configured to implement the data processing functions performed by the terminal devices in the methods provided in embodiments of the disclosure. The apparatus 240 may further include a communication interface 2410. The communication interface 2410 is configured to implement the transceiving operations performed by the terminal devices in the methods provided in embodiments of the disclosure. In embodiments of the disclosure, the communication interface may be a transceiver, a circuit, a bus, a module, or another type of communication interface, for communicating with other devices via a transmission medium. For example, the communication interface 2410 is configured to perform communication between an apparatus in the apparatus 240 and another device. The processor 2420 is configured to transmit and receive data via the communication interface 2410, and to implement the methods illustrated in FIG. 5, FIG. 7, FIG. 16, and FIG. 17 in the method embodiments above.

The apparatus 240 may further include at least one memory 2430. The memory 2430 is configured to store program instructions and/or data. The memory 2430 is coupled with the processor 2420. The coupling in embodiments of the disclosure may be an indirect coupling or communication connection through an apparatus, a unit or a module, and may be in electrical, mechanical or other forms, for information interaction among the apparatus, the unit or the module. The processor 2420 may perform operations in cooperation with the memory 2430. The processor 2420 may be configured to execute program instructions stored in the memory 2430. At least one of the at least one memory may be included in the processor.

Upon boot-up of the apparatus 240, the processor 2420 can read software programs stored in the memory 2430, construe and execute instructions in the software programs, and process data in the software programs. When data needs to be transmitted in a wireless manner, the processor 2420 outputs a baseband signal to a radio frequency (RF) circuit (not illustrated in FIGs) after performing baseband processing on the data to be transmitted. The RF circuit transmits through an antenna an RF signal outward in the form of an electromagnetic wave after performing RF processing on the baseband signal. When the data is transmitted to the apparatus 240, the RF circuit receives the RF signal through the antenna, converts the RF signal into the baseband signal, and outputs the baseband signal to the processor 2420. The processor 2420 converts the baseband signal into the data and performs data processing.

In another embodiment, the RF circuit and the antenna may be disposed independent of the processor 2420 that can perform baseband processing. For example, in a distributed scenario, the RF circuit and the antenna may be independent of the communication apparatus and disposed in a remote manner.

In embodiments of the disclosure, a specific connection medium among the communication interface 2410, the processor 2420, and the memory 2430 is not limited. In embodiments of the disclosure, the memory 2430, the processor 2420, and the communication interface 2410 are connected through a bus 2440 in FIG. 24, where the bus is represented by a thick line in FIG. 24, and a connection manner between other components is only for illustrative descriptions and is not limited thereto. The bus may be classified into an address bus, a data bus, a control bus, and the like. For the convenience of representation, only one thick line is illustrated in FIG. 24, which, however, does not mean that there is only one bus or one type of bus.

When the apparatus 240 is specifically configured for the terminal device, for example, when the apparatus 240 is specifically the chip or the SOC, the communication interface 2410 may output or receive the baseband signal. When the apparatus 240 is specifically the terminal device, the communication interface 2410 may output or receive the RF signal. In embodiments of the disclosure, the processor may be a general-purpose processor, a digital signal processor (DSP), an application specific integrated circuit (ASIC), a field programmable gate array (FPGA), or other programmable logic devices, discrete gates or transistor logic devices, discrete hardware components. The methods, operations, and logic blocks disclosed in embodiments can be implemented or executed. The general-purpose processor may be a microprocessor or any conventional processor or the like. The operations of the method disclosed in embodiments may be directly implemented as a hardware processor, or may be performed by hardware and software modules in the processor.

It is to be noted that, the communication apparatus may execute related operations of the terminal devices or the access-network devices in the foregoing method embodiments. For details, reference can be made to the embodiments provided in the foregoing operations, which will not be repeated herein.

For each apparatus and product applied to or integrated into the communication apparatus, each module included can be implemented by hardware such as circuits, and different modules can be located in a same component (such as a chip, a circuit module, and the like) or different components in the UE, or at least part of modules can be implemented by software programs that run on the processor integrated into the UE, and the rest (if any) of modules can be implemented by hardware such as circuits.

A chip is further provided in embodiments of the disclosure. The chip may execute related operations of the terminal devices in the foregoing method embodiments. The chip is configured to determine a first time-domain resource unavailable for a PUSCH repetition type B transmission, when a time-domain resource for the PUSCH repetition type B transmission overlaps an idle period in a fixed frame period for channel occupancy by a network device, and the terminal device is unable to transmit an uplink channel in the idle period.

Optionally, the chip is further configured to segment the time-domain resource for the PUSCH repetition type B transmission into a second time-domain resource and a third time-domain resource based on the first time-domain resource, where the second time-domain resource is located before the first time-domain resource and the third time-domain resource is located after the first time-domain resource.

Optionally, the chip is further configured to perform the PUSCH repetition type B transmission in the second time-domain resource; and to perform the PUSCH repetition type B transmission in the third time-domain resource when receiving a downlink channel transmission.

Optionally, the chip is further configured to perform the PUSCH repetition type B transmission in the third time-domain resource and in a clear channel when the chip does not receive any downlink channel transmission and the clear channel is detected.

Optionally, the downlink channel transmission is first indication information, and the first indication information indicates to perform the PUSCH repetition type B transmission in the third time-domain resource.

Optionally, the chip is further configured to pad a target slot symbol when the target slot symbol exists, where the target slot symbol is a slot symbol between the first time-domain resource and the second time-domain resource, or the target slot symbol is a slot symbol between the first time-domain resource and the third time-domain resource, or the target slot symbol is a slot symbol before or after a slot boundary in the second time-domain resource, or the target slot symbol is a slot symbol before or after a slot boundary in the third time-domain resource.

Optionally, the chip, before segmenting the time-domain resource for the PUSCH repetition type B transmission into the second time-domain resource and the third time-domain resource based on the first time-domain resource, is further configured to pad a target slot symbol when the target slot symbol exists, where the target slot symbol is a slot symbol between two adjacent PUSCH transmissions in one or more PUSCH transmissions, or the target slot symbol is a slot symbol before a first PUSCH transmission in the one or more PUSCH transmissions, or the target slot symbol is a slot symbol after a last PUSCH transmission in the one or more PUSCH transmissions; where the multiple PUSCH transmissions are obtained by segmenting a PUSCH and the PUSCH repetition type B transmission.

Optionally, the target slot symbol is the slot symbol between the first time-domain resource and the second time-domain resource, or the target slot symbol is the slot symbol between the first time-domain resource and the third time-domain resource. The chip, configured to pad the target slot symbol, is specifically configured to pad the target slot symbol by using an extended CP of a first slot symbol in the third time-domain resource.

Optionally, the chip, configured to pad the target slot symbol, is specifically configured to pad the target slot symbol by using an extended CP of a next slot symbol to the target slot symbol, or pad the target slot symbol by using an extended CP of a previous slot symbol to the target slot symbol.

Optionally, the chip, configured to pad the target slot symbol, is specifically configured to pad the target slot symbol by using data in a first slot symbol for a next PUSCH repetition transmission, or pad the target slot symbol by using data in a last slot symbol for a previous PUSCH repetition transmission.

Optionally, the chip, configured to determine the first time-domain resource unavailable for the PUSCH repetition type B transmission, is specifically configured to determine the idle period as the first time-domain resource unavailable for the PUSCH repetition type B transmission.

Optionally, the chip, configured to determine the first time-domain resource unavailable for the PUSCH repetition type B transmission, is specifically configured to receive second indication information from the network device, where the second indication information indicates a time-domain resource unavailable for the PUSCH repetition type B transmission; and to determine the first time-domain resource unavailable for the PUSCH repetition type B transmission based on the second indication information.

Optionally, the PUSCH repetition type B transmission is a dynamically scheduled PUSCH repetition transmission or a scheduled and granted PUSCH repetition transmission activated by a PDCCH. The chip, configured to segment the time-domain resource for the PUSCH repetition type B transmission into the second time-domain resource and the third time-domain resource based on the first time-domain, is specifically configured to segment the time-domain resource for the PUSCH repetition type B transmission into the second time-domain resource and the third time-domain resource based on the first time-domain resource when the chip receives third indication information and DCI from the network device, and the third indication information indicates existence of fourth indication information in the DCI, and the fourth indication information indicates validity of the second indication information; where the third indication information indicates whether the fourth indication information exists in the DCI, and the fourth indication information indicates whether the second indication information is valid.

Optionally, the chip is further configured to segment the time-domain resource for the PUSCH repetition type B transmission into the second time-domain resource and the third time-domain resource based on the first time-domain resource, when the chip receives third indication information and DCI from the network device, and the third indication information indicates absence of fourth indication information in the DCI.

Optionally, the PUSCH repetition type B transmission is a scheduled and granted PUSCH repetition transmission activated by a non-PDCCH. The chip, configured to segment the time-domain resource for the PUSCH repetition type B transmission into the second time-domain resource and the third time-domain resource based on the first time-domain, is specifically configured to segment the time-domain resource for the PUSCH repetition type B transmission into the second time-domain resource and the third time-domain resource based on the first time-domain resource when not receiving third indication information from the network device, where the third indication information indicates whether fourth indication information exists in DCI, and the fourth indication information indicates whether the second indication information is valid.

In a possible embodiment, the chip above includes at least one processor, at least one first memory, and at least one second memory. The at least one first memory and the at least one processor are interconnected through a line, and the first memory above is configured to store instructions. The at least one second memory and the at least one processor are interconnected through a line, and the second memory above is configured to store data that needs to be stored in the foregoing method embodiments.

For each apparatus and product applied to or integrated into the chip, each module included can be implemented by hardware such as circuits, or at least part of modules can be implemented by software programs that run on a processor integrated into the chip, and the rest (if any) of modules can be implemented by hardware such as circuits.

A chip is further provided in embodiments of the disclosure. The chip may execute related operations of the terminal devices in the foregoing method embodiments. The chip is configured to pad a target slot symbol, where the target slot symbol is a slot symbol between two adjacent PUSCH transmissions in one or more PUSCH transmissions, or the target slot symbol is a slot symbol before a first PUSCH transmission in the one or more PUSCH transmissions, or the target slot symbol is a slot symbol after a last PUSCH transmission in the one or more PUSCH transmissions; where the multiple PUSCH transmissions are obtained by segmenting a PUSCH and a PUSCH repetition transmission.

Optionally, the chip, configured to pad the target slot symbol, is specifically configured to pad the target slot symbol by using an extended CP of a next slot symbol to the target slot symbol.

Optionally, the chip, configured to pad the target slot symbol, is specifically configured to pad the target slot symbol by using an extended CP of a previous slot symbol to the target slot symbol.

Optionally, the chip, configured to pad the target slot symbol, is specifically configured to pad the target slot symbol by using data in a first slot symbol for a next PUSCH repetition transmission.

Optionally, the chip, configured to pad the target slot symbol, is specifically configured to pad the target slot symbol by using data in a last slot symbol for a previous PUSCH repetition transmission.

In a possible embodiment, the chip above includes at least one processor, at least one first memory, and at least one second memory. The at least one first memory and the at least one processor are interconnected through a line, and the first memory above is configured to store instructions. The at least one second memory and the at least one processor are interconnected through a line, and the second memory above is configured to store data that needs to be stored in the foregoing method embodiments.

For each apparatus and product applied to or integrated into the chip, each module included can be implemented by hardware such as circuits, or at least part of modules can be implemented by software programs that run on a processor integrated into the chip, and the rest (if any) of modules can be implemented by hardware such as circuits.

As illustrated in FIG. 25, FIG. 25 is a schematic structural diagram of a module device provided in embodiments of the disclosure. The module device 250 may execute related operations of the terminal devices in the foregoing method embodiments. The module device 250 includes a communication module 2501, a power module 2502, a storage module 2503, and a chip module 2504.

The power module 2502 is configured to supply power to the module device. The storage module 2503 is configured to store data and instructions. The communication module 2501 is configured to perform internal communication in the module device or configured to perform communication between the module device and an external device. The chip module 2504 is configured to determine a first time-domain resource unavailable for a PUSCH repetition type B transmission, when a time-domain resource for the PUSCH repetition type B transmission overlaps an idle period in a fixed frame period for channel occupancy by a network device, and the terminal device is unable to transmit an uplink channel in the idle period; segment the time-domain resource for the PUSCH repetition type B transmission into a second time-domain resource and a third time-domain resource based on the first time-domain resource, where the second time-domain resource is located before the first time-domain resource and the third time-domain resource is located after the first time-domain resource.

Optionally, the chip module 2504 is further configured to perform the PUSCH repetition type B transmission in the second time-domain resource; and to perform the PUSCH repetition type B transmission in the third time-domain resource when receiving a downlink channel transmission.

Optionally, the chip module 2504 is further configured to perform the PUSCH repetition type B transmission in the third time-domain resource and in a clear channel when the chip module 2504 does not receive any downlink channel transmission and the clear channel is detected.

Optionally, the downlink channel transmission is first indication information, and the first indication information indicates to perform the PUSCH repetition type B transmission in the third time-domain resource.

Optionally, the chip module 2504 is further configured to pad a target slot symbol when the target slot symbol exists, where the target slot symbol is a slot symbol between the first time-domain resource and the second time-domain resource, or the target slot symbol is a slot symbol between the first time-domain resource and the third time-domain resource, or the target slot symbol is a slot symbol before or after a slot boundary in the second time-domain resource, or the target slot symbol is a slot symbol before or after a slot boundary in the third time-domain resource.

Optionally, the chip module 2504, before segmenting the time-domain resource for the PUSCH repetition type B transmission into the second time-domain resource and the third time-domain resource based on the first time-domain resource, is further configured to pad a target slot symbol when the target slot symbol exists, where the target slot symbol is a slot symbol between two adjacent PUSCH transmissions in one or more PUSCH transmissions, or the target slot symbol is a slot symbol before a first PUSCH transmission in the one or more PUSCH transmissions, or the target slot symbol is a slot symbol after a last PUSCH transmission in the one or more PUSCH transmissions; where the multiple PUSCH transmissions are obtained by segmenting a PUSCH and the PUSCH repetition type B transmission.

Optionally, the target slot symbol is the slot symbol between the first time-domain resource and the second time-domain resource, or the target slot symbol is the slot symbol between the first time-domain resource and the third time-domain resource. The chip module 2504, configured to pad the target slot symbol, is specifically configured to pad the target slot symbol by using an extended CP of a first slot symbol in the third time-domain resource.

Optionally, the chip module 2504, configured to pad the target slot symbol, is specifically configured to pad the target slot symbol by using an extended CP of a next slot symbol to the target slot symbol, or pad the target slot symbol by using an extended CP of a previous slot symbol to the target slot symbol.

Optionally, the chip module 2504, configured to pad the target slot symbol, is specifically configured to pad the target slot symbol by using data in a first slot symbol for a next PUSCH repetition transmission, or pad the target slot symbol by using data in a last slot symbol for a previous PUSCH repetition transmission.

Optionally, the chip module 2504, configured to determine the first time-domain resource unavailable for the PUSCH repetition type B transmission, is specifically configured to determine the idle period as the first time-domain resource unavailable for the PUSCH repetition type B transmission.

Optionally, the chip module 2504, configured to determine the first time-domain resource unavailable for the PUSCH repetition type B transmission, is specifically configured to receive second indication information from the network device, where the second indication information indicates a time-domain resource unavailable for the PUSCH repetition type B transmission; and to determine the first time-domain resource unavailable for the PUSCH repetition type B transmission based on the second indication information.

Optionally, the PUSCH repetition type B transmission is a dynamically scheduled PUSCH repetition transmission or a scheduled and granted PUSCH repetition transmission activated by a PDCCH. The chip module 2504, configured to segment the time-domain resource for the PUSCH repetition type B transmission into the second time-domain resource and the third time-domain resource based on the first time-domain, is specifically configured to segment the time-domain resource for the PUSCH repetition type B transmission into the second time-domain resource and the third time-domain resource based on the first time-domain resource when the chip module 2504 receives third indication information and DCI from the network device, and the third indication information indicates existence of fourth indication information in the DCI, and the fourth indication information indicates validity of the second indication information; where the third indication information indicates whether the fourth indication information exists in the DCI, and the fourth indication information indicates whether the second indication information is valid.

Optionally, the chip module 2504 is further configured to segment the time-domain resource for the PUSCH repetition type B transmission into the second time-domain resource and the third time-domain resource based on the first time-domain resource, when the chip module 2504 receives third indication information and DCI from the network device, and the third indication information indicates absence of fourth indication information in the DCI.

Optionally, the PUSCH repetition type B transmission is a scheduled and granted PUSCH repetition transmission activated by a non-PDCCH. The chip module 2504, configured to segment the time-domain resource for the PUSCH repetition type B transmission into the second time-domain resource and the third time-domain resource based on the first time-domain, is specifically configured to segment the time-domain resource for the PUSCH repetition type B transmission into the second time-domain resource and the third time-domain resource based on the first time-domain resource when not receiving third indication information from the network device; where the third indication information indicates whether fourth indication information exists in DCI, and the fourth indication information indicates whether the second indication information is valid.

For each apparatus and product applied to or integrated into the chip module, each module included can be implemented by hardware such as circuits, and different modules can be located in a same component (such as a chip, a circuit module, and the like) or different components in the chip module, or at least part of modules can be implemented by software programs that run on the processor integrated into the chip module, and the rest (if any) of modules can be implemented by hardware such as circuits. A computer-readable storage medium is further provided in embodiments of the disclosure. The computer-readable storage medium is configured to store instructions, which, when executed by a processor, are operable with the processor to implement the method procedures in the foregoing method embodiments.

As illustrated in FIG. 25, FIG. 25 is a schematic structural diagram of a module device provided in embodiments of the disclosure. The module device 250 may execute related operations of the terminal devices in the foregoing method embodiments. The module device 250 includes a communication module 2501, a power module 2502, a storage module 2503, and a chip module 2504.

The power module 2502 is configured to supply power to the module device. The storage module 2503 is configured to store data and instructions. The communication module 2501 is configured to perform internal communication in the module device or configured to perform communication between the module device and an external device. The chip module 2504 is configured to pad a target slot symbol, where the target slot symbol is a slot symbol between two adjacent PUSCH transmissions in one or more PUSCH transmissions, or the target slot symbol is a slot symbol before a first PUSCH transmission in the one or more PUSCH transmissions, or the target slot symbol is a slot symbol after a last PUSCH transmission in the one or more PUSCH transmissions; where the multiple PUSCH transmissions are obtained by segmenting a PUSCH and a PUSCH repetition transmission.

Optionally, the chip module 2504, configured to pad the target slot symbol, is specifically configured to pad the target slot symbol by using an extended CP of a next slot symbol to the target slot symbol.

Optionally, the chip module 2504, configured to pad the target slot symbol, is specifically configured to pad the target slot symbol by using an extended CP of a previous slot symbol to the target slot symbol.

Optionally, the chip module 2504, configured to pad the target slot symbol, is specifically configured to pad the target slot symbol by using data in a first slot symbol for a next PUSCH repetition transmission.

Optionally, the chip module 2504, configured to pad the target slot symbol, is specifically configured to pad the target slot symbol by using data in a last slot symbol for a previous PUSCH repetition transmission.

For each apparatus and product applied to or integrated into the chip module, each module included can be implemented by hardware such as circuits, and different modules can be located in a same component (such as a chip, a circuit module, and the like) or different components in the chip module, or at least part of modules can be implemented by software programs that run on the processor integrated into the chip module, and the rest (if any) of modules can be implemented by hardware such as circuits. A computer-readable storage medium is further provided in embodiments of the disclosure. The computer-readable storage medium is configured to store instructions, which, when executed by a processor, are operable with the processor to implement the method procedures in the foregoing method embodiments.

A computer program product is further provided in embodiments of the disclosure, which, when executed by a processor, are operable with the processor to implement the method procedures in the foregoing method embodiments.

It is to be noted that, for the sake of simplicity, the foregoing method embodiments are described as a series of action combinations. However, it will be appreciated by those skilled in the art that embodiments are not limited by the sequence of actions described. According to embodiments, some steps or operations may be performed in other orders or simultaneously.

Besides, it will be appreciated by those skilled in the art that the embodiments described in the specification are exemplary embodiments, and the actions and modules involved are not necessarily essential to the disclosure.

In the foregoing embodiments, the description of each embodiment can refer to each other, and the description of each embodiment has its own emphasis. For the parts not described in detail in one embodiment, reference can be made to related descriptions in other embodiments. For the sake of convenience and simplicity, for example, in terms of the functions and operations of each apparatus and device in embodiments of the disclosure, reference can be made to the related descriptions of the method embodiments, and reference or citation can also be made to each other between the method embodiments and between the apparatus embodiments.

Finally, it is to be noted that, the foregoing embodiments are only for the purpose of illustrating the technical solutions rather than limiting the disclosure. Although the disclosure is described in detail with reference to the foregoing embodiments, it will be understood by those of ordinary skill in the art that modifications can be made to the technical solutions described in the foregoing embodiments, or that equivalent arrangements can be made to some or all technical features thereof. In terms of the essence of the corresponding technical solutions, these modifications or equivalent arrangements shall also fall within the scope of protection of the technical solutions of embodiments of the disclosure.

1. A method for uplink channel transmission, comprising:
determining, by a terminal device, a first time-domain resource unavailable for a physical uplink shared channel (PUSCH) repetition type B transmission, in response to a time-domain resource for the PUSCH repetition type B transmission overlapping an idle period in a fixed frame period for channel occupancy by a network device, and the terminal device being unable to transmit an uplink channel in the idle period; and
segmenting, by the terminal device, the time-domain resource for the PUSCH repetition type B transmission into a second time-domain resource and a third time-domain resource based on the first time-domain resource, the second time-domain resource being located before the first time-domain resource and the third time-domain resource being located after the first time-domain resource.

2. The method of claim 1, further comprising:
performing, by the terminal device, the PUSCH repetition type B transmission in the second time-domain resource; and
performing, by the terminal device, the PUSCH repetition type B transmission in the third time-domain resource, in response to receiving a downlink channel transmission.

3. The method of claim 2, further comprising:
performing, by the terminal device, the PUSCH repetition type B transmission in the third time-domain resource and in a clear channel, in response to not receiving any downlink channel transmission and the clear channel being detected.

4. The method of claim 2, wherein the downlink channel transmission is first indication information, and the first indication information indicates the terminal device to perform the PUSCH repetition type B transmission in the third time-domain resource.

5. The method of claim 1, further comprising:
padding, by the terminal device, a target slot symbol in response to existence of the target slot symbol, wherein the target slot symbol is a slot symbol between the first time-domain resource and the second time-domain resource, or the target slot symbol is a slot symbol between the first time-domain resource and the third time-domain resource, or the target slot symbol is a slot symbol before or after a slot boundary in the second time-domain resource, or the target slot symbol is a slot symbol before or after a slot boundary in the third time-domain resource.

6. The method of claim 1, wherein before segmenting, by the terminal device, the time-domain resource for the PUSCH repetition type B transmission into the second time-domain resource and the third time-domain resource based on the first time-domain resource, the method comprises:
padding, by the terminal device, a target slot symbol in response to existence of the target slot symbol, wherein the target slot symbol is a slot symbol between two adjacent PUSCH transmissions in a plurality of PUSCH transmissions, or the target slot symbol is a slot symbol before a first PUSCH transmission in one or the plurality of PUSCH transmissions, or the target slot symbol is a slot symbol after a last PUSCH transmission in the one or the plurality of PUSCH transmissions; wherein
the plurality of PUSCH transmissions are obtained by segmenting a PUSCH and the PUSCH repetition type B transmission.

7. The method of claim 5, wherein the target slot symbol is the slot symbol between the first time-domain resource and the second time-domain resource, or the target slot symbol is the slot symbol between the first time-domain resource and the third time-domain resource; and
padding, by the terminal device, the target slot symbol comprises:
padding, by the terminal device, the target slot symbol by using an extended cyclic prefix (CP) of a first slot symbol in the third time-domain resource.

8. The method of claim 5, wherein padding, by the terminal device, the target slot symbol comprises:
padding, by the terminal device, the target slot symbol by using an extended CP of a next slot symbol to the target slot symbol; or padding, by the terminal device, the target slot symbol by using an extended CP of a previous slot symbol to the target slot symbol.

9. The method of claim 5, wherein padding, by the terminal device, the target slot symbol comprises:
padding, by the terminal device, the target slot symbol by using data in a first slot symbol for a next PUSCH repetition type B transmission; or padding, by the terminal device, the target slot symbol by using data in a last slot symbol for a previous PUSCH repetition type B transmission.

10. The method of claim 1, wherein determining, by the terminal device, the first time-domain resource unavailable for the PUSCH repetition type B transmission comprises:
determining, by the terminal device, the idle period as the first time-domain resource unavailable for the PUSCH repetition type B transmission.

11. The method of claim 1, wherein determining, by the terminal device, the first time-domain resource unavailable for the PUSCH repetition type B transmission comprises:
receiving, by the terminal device, second indication information from the network device, wherein the second indication information indicates a time-domain resource unavailable for the PUSCH repetition type B transmission; and
determining, by the terminal device, the first time-domain resource unavailable for the PUSCH repetition type B transmission based on the second indication information.

12. The method of claim 11, wherein the PUSCH repetition type B transmission is a dynamically scheduled PUSCH repetition transmission or a scheduled and granted PUSCH repetition transmission activated by a physical downlink control channel (PDCCH); and segmenting, by the terminal device, the time-domain resource for the PUSCH repetition type B transmission into the second time-domain resource and the third time-domain resource based on the first time-domain resource comprises:
segmenting, by the terminal device, the time-domain resource for the PUSCH repetition type B transmission into the second time-domain resource and the third time-domain resource based on the first time-domain resource, in response to receiving third indication information and downlink control information (DCI) from the network device, the third indication information indicating existence of fourth indication information in the DCI, and the fourth indication information indicating validity of the second indication information; wherein
the third indication information indicates whether the fourth indication information exists in the DCI, and the fourth indication information indicates whether the second indication information is valid.

13. The method of claim 12, further comprising:
segmenting, by the terminal device, the time-domain resource for the PUSCH repetition type B transmission into the second time-domain resource and the third time-domain resource based on the first time-domain resource, in response to receiving the third indication information and the DCI from the network device, and the third indication information indicating absence of the fourth indication information in the DCI.

14. The method of claim 11, wherein the PUSCH repetition type B transmission is a scheduled and granted PUSCH repetition transmission activated by a non-PDCCH; and segmenting, by the terminal device, the time-domain resource for the PUSCH repetition type B transmission into the second time-domain resource and the third time-domain resource based on the first time-domain resource comprises:
segmenting, by the terminal device, the time-domain resource for the PUSCH repetition type B transmission into the second time-domain resource and the third time-domain resource based on the first time-domain resource, in response to not receiving third indication information from the network device; wherein
the third indication information indicates whether fourth indication information exists in DCI, and the fourth indication information indicates whether the second indication information is valid.

15-20. (canceled)

21. A communication apparatus, comprising:
a transceiver configured to receive or transmit a signal;
a memory configured to store computer programs; and
a processor configured to invoke the computer programs stored in the memory:
determine a first time-domain resource unavailable for a physical uplink shared channel (PUSCH) repetition type B transmission, in response to a time-domain resource for the PUSCH repetition type B transmission overlapping an idle period in a fixed frame period for channel occupancy by a network device, and the terminal device being unable to transmit an uplink channel in the idle period; and
segment the time-domain resource for the PUSCH repetition type B transmission into a second time-domain resource and a third time-domain resource based on the first time-domain resource, the second time-domain resource being located before the first time-domain resource and the third time-domain resource being located after the first time-domain resource.

22-26. (canceled)

27. A non-transitory computer-readable storage medium configured to store computer-readable instructions which, when executed by a communication apparatus, are operable with the communication apparatus to perform:
determining a first time-domain resource unavailable for a physical uplink shared channel (PUSCH) repetition type B transmission, in response to a time-domain resource for the PUSCH repetition type B transmission overlapping an idle period in a fixed frame period for channel occupancy by a network device, and the terminal device being unable to transmit an uplink channel in the idle period; and
segmenting the time-domain resource for the PUSCH repetition type B transmission into a second time-domain resource and a third time-domain resource based on the first time-domain resource, the second time-domain resource being located before the first time-domain resource and the third time-domain resource being located after the first time-domain resource.

28. The communication apparatus of claim 21, wherein the processor is further configured to invoke the computer programs stored in the memory to:
perform the PUSCH repetition type B transmission in the second time-domain resource; and
perform the PUSCH repetition type B transmission in the third time-domain resource, in response to receiving a downlink channel transmission.

29. The non-transitory computer-readable storage medium of claim 27, wherein the computer-readable instructions are further operable with the communication apparatus to perform:
before segmenting, by the terminal device, the time-domain resource for the PUSCH repetition type B transmission into the second time-domain resource and the third time-domain resource based on the first time-domain resource, the method comprises:
padding, by the terminal device, a target slot symbol in response to existence of the target slot symbol, wherein the target slot symbol is a slot symbol between two adjacent PUSCH transmissions in a plurality of PUSCH transmissions, or the target slot symbol is a slot symbol before a first PUSCH transmission in one or the plurality of PUSCH transmissions, or the target slot symbol is a slot symbol after a last PUSCH transmission in the one or the plurality of PUSCH transmissions; wherein
the plurality of PUSCH transmissions are obtained by segmenting a PUSCH and the PUSCH repetition type B transmission.

30. The non-transitory computer-readable storage medium of claim 29, wherein the target slot symbol is the slot symbol between the first time-domain resource and the second time-domain resource, or the target slot symbol is the slot symbol between the first time-domain resource and the third time-domain resource; and
in terms of padding, by the terminal device, the target slot symbol, the computer-readable instructions are further operable with the communication apparatus to perform:
padding, by the terminal device, the target slot symbol by using an extended cyclic prefix (CP) of a first slot symbol in the third time-domain resource.

31. The non-transitory computer-readable storage medium of claim 29, wherein in terms of padding, by the terminal device, the target slot symbol, the computer-readable instructions are further operable with the communication apparatus to perform:
padding, by the terminal device, the target slot symbol by using an extended CP of a next slot symbol to the target slot symbol; or padding, by the terminal device, the target slot symbol by using an extended CP of a previous slot symbol to the target slot symbol.
